(19) United States
(12) Patent Application Publication
(10) Pub. No.: US 2003/0018490 A1
(43) Pub. Date: Jan. 23, 2003

(54) Object oriented system and method for planning and implementing supply-chains

(75) Inventors: Allyn E. Magers, The Woodlands, TX (US); Surya Rajan, Houston, TX (US); Carl Patrick Seaton, Sugar Land, TX (US); Janet Lynn Gerken, Findlay, OH (US); Leo Russell Bonaparte, Findlay, OH (US); Radhakrishnan Bandarpalle, Plano, TX (US); Thomas Lee Walters, Sugar Land, TX (US)

Correspondence Address: BAKER BOTTS, LLP, 910 LOUISIANA, HOUSTON, TX, 77002-4995, US

(73) Assignee: Marathon Ashland Petroleum L.L.C.

(21) Appl. No.: 10/190,891

(22) Filed: Jul. 8, 2002

Related U.S. Application Data
(60) Provisional application No. 60/303,570, filed on Jul. 6, 2001.

(51) Int. Cl. G06F 17/60

(52) U.S. Cl. 705/1

(57) ABSTRACT

A system, method, and apparatus are provided for simulating real-world logistical systems in a virtual environment. Sets of objects are provided with various properties and methods for performing various functions, such as pricing, movement, demand, etc. The objects are sheathed in a framework the enables the objects to operate in a semi-autonomous fashion to create a virtual environment. Instances of the objects in the virtual environment are then provided with real-world information, such as commodity or service-type, amount, location, etc as the properties of the object instances. The framework enables the objects to interact, through their attendant methods, within the virtual environment so that the behavior of the overall system emerges. The emergent behavior can then be observed, optimized and corrective action taken, if necessary.

### CROSS-REFERENCE TO RELATED APPLICATIONS

This application is related to U.S. provisional patent application serial No. 60/303,570, entitled “Accretive Object Oriented Acquisition, Supply and Trading Business Process” which was filed on Jul. 6, 2001, and which is incorporated herein by reference in its entirety for all purposes.

### BACKGROUND OF THE INVENTION TECHNOLOGY

1. Field of the Invention

The present invention is related to supply chains. More particularly, the present invention is related to the automation of supply chains, and the optimization of supply chains and their management.

2. Description of the Related Art

Current supply chain management tools typically model one of the elements of a supply chain. For example some supply chain systems focus on the transport of the commodity. Other modeling systems focus on the contract formation; others on collaboration or messaging. Still others concentrate on the scheduling.

In the prior art, construction of supply chain management tools took a “top-down” approach to tool development. The “top-down” approach led to largely single-element models replicating organizational silos (i.e., trading, scheduling, contract administration, transportation), supply chain model gaps, cumbersome software or human interfaces to attempt effective and comprehensive supply chain management. In prior art, comprehensive supply chain models (i.e., those that combine multiple elements) were fashioned by fusing new or existing single-element software packages. The single-element software packages did not accommodate effective interaction with outside systems, they did not function as a producer or as a receptacle for comprehensive supply chain data and information, and they required a separate management system that imposed “top-down” control and coordination upon the fused packages. Unfortunately, the top-down and single-element development approach led to supply chain management tools that do not comport with real life supply chains and thus are of limited ability. Therefor, there is a need in the art for a system or method that integrates disparate elements of the supply chain that better mimics real life supply chains.

### SUMMARY OF THE INVENTION

The present invention remedies the shortcomings of the prior art by providing a system and method for mirroring real life supply chains in a way that enables the modeling and optimization of those supply chains. The present invention also provides an apparatus, system and method integrates supply chain forecasting, planning, trading, scheduling, contract administration, physical and financial position management, accounting and other supply chain functions and operations that occur within an existing supply chain from suppliers to end customers.

The present invention utilizes a specifically configured set of objects to capture and exploit data about a supply chain. The objects are configured in a way that more closely mimics real life supply chains and thus provides superior performance to top-down or single-element-centric managed systems. The objects of the present invention can be standard objects operating within a virtual environment. Moreover, the objects of the present invention may be semi-autonomous or completely autonomous in operation. The present invention embodies various objects developed to support various workflow processes such as manufacturing, forecasting, master planning, MRP (material requirements planning), capacity management, production activity control, purchasing, inventory management, distribution, TQM (total quality management), JIT (Just-in-Time) manufacturing, demand pull planning, supply push planning, documentation, auditing, contractual, regulatory and compliance reporting etc. without constraining the planning process to a specific planning model; this is accomplished by translating real world business concepts and their relationships into system objects and interacting object models. For example, the present invention:

Enables supply chain participants to work from a shared, comprehensive and integrated end-to-end information system;

Reduces or eliminates disjointed paper and electronic documents, spreadsheets, databases, legacy applications and interfaces;

Improves data capture, accuracy and use;

Provides single point data entry;

Handles any real-time or delayed level of data and information availability;

Avoids and increases detection of numerous supply chain problems;

Provides more options by decreasing supply chain planning and reaction cycle times. Increased number of options creates additional value-adding opportunities and problem avoidance, as actions can be delayed longer allowing acquisition and response to additional information before triggering actions;

Enhances supply chain ratability and reliability;

Allows supply chain product, distribution, and financial opportunity prospecting and what-if analysis;

Reduces missed supply chain opportunities resulting from physical inventory, logistical and financial position uncertainty;

Facilitates maintenance of reference or master data such as counter-party identification and goods distribution routing because the subject data will involve only one system, not three or more, as all information, including reference data is streamlined into one integrated end-to-end solution;

Enables detailed cost capture, analysis, auditing and reporting, demurrage, transportation costs, contamination and other secondary costs can be captured at a more detailed level, such as by vessel or carrier. At this level, it can be used for analysis of trends. This would enable being more selective when choosing carriers or aid in recovering claims related to grade degradation;

Reduces the cost of supply chain operations, including scheduling, inventory management, authorizing, documenting and communicating activity and results, management and transaction cost;

Enables executing quality initiatives, waste reduction, and continuous improvement plans implementation;

Supports executing quality and continuous improvement initiatives. Better information and logistical capabilities could allow increases in the volume of the optimized product slate;

Facilitates regulatory compliance and reporting; and

Permits full collaboration and integration of market place activities, with high data security between trading partners, shippers, suppliers, transporters, labs, and inspection companies.

The present invention enables dynamic usage of object data a most opportunistic and efficient manner. The system of the present invention allows for the employment, based upon operation requirements, of functional objects. The operational requirements, and thus the behavior of the objects of the present invention, may be modified in real-time based on operational realities. This provides the present invention with the ability to model, in real-time, all aspects of the supply chain, and to change business rules of the objects themselves in a dynamic manner in order to comport to the new operational realities. Moreover, the objects of the present invention may receive input from various external operational processes and devices and allow the behavior of a portion or all of the supply chain to emerge and be observed.

The present invention may use real-world inputs in virtual models that are used to test proposed supply chain configurations so that more advantageous configurations may be obtained. For example, the system of the present invention can contain objects that are instantiated based on real-world numbers. However, movement of the goods that are represented by those instantiated objects may be processed in a variety of scenarios in order to find which supply chain configuration provides the best performance under a user-defined criteria, such as minimum cost.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a block diagram illustrating the architecture of the present invention.

FIG. 2 is a flowchart illustrating an embodiment of the method of the present invention.

FIG. 3 is a modeling diagram illustrating the relationships of objects associated with the present invention.

FIG. 4 is a modeling diagram illustrating the relationships of objects associated with the present invention.

FIG. 5 is a modeling diagram illustrating the relationships of objects associated with the present invention.

FIG. 6 is a modeling diagram illustrating the relationships of objects associated with the present invention.

FIG. 7 is a flowchart illustrating an embodiment of the method of the present invention.

FIG. 8 is a modeling diagram illustrating the relationships of objects associated with the present invention.

FIG. 9 is a block diagram contrasting two Net Out conditions according to the teachings of the present invention.

FIG. 10 is a block diagram illustrating an embodiment of the system of the present invention.

FIG. 11 is a block diagram illustrating the interfaces that are capable of interacting with the business services according to the teachings of the present invention.

FIG. 12 is a block diagram illustrating the communicative nature that is associated with the architecture of the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention as defined by the appended claims are intended to be covered.

### DETAILED DESCRIPTION OF SPECIFIC EMBODIMENTS

The present invention is directed to the modeling of supply chains. More specifically, the present invention is directed to the modeling and optimization of the means of determining the need for purchase, manufacture or sale of goods, the contract management, goods storage, transportation and inventory management, price and cost tracking, and the collaboration tools necessary to transport a good from its origin to its final point of sale, exchange or consumption.

1. Overall Architecture

The architecture of the system 100 of the present invention is comprised of three inter-communicating layers: technical, business, and client. Each layer provides specific functionality pertaining to technical, business or client services. Further, each layer comprises other logical components that provide functional services. Each of the functional services can communicate with each other over a communication network. Alternatively, all of the functional services and/or layers can reside on one physical device. The communication is achieved through specific interfaces.

The present invention is composed of a set of objects, in the form of an object engine, that operate in a multi-tiered environment in order to implement business logic of various types. In the preferred embodiment of the present invention, the objects of the present invention provide various functions called business services and operate in the business services layer. Basic functionality for the objects of the present invention is provided by the technical services layer. Various user interfaces may be used to observer and/or control various aspects of the object engine, and those user interfaces are generally grouped together to form a client services layer.

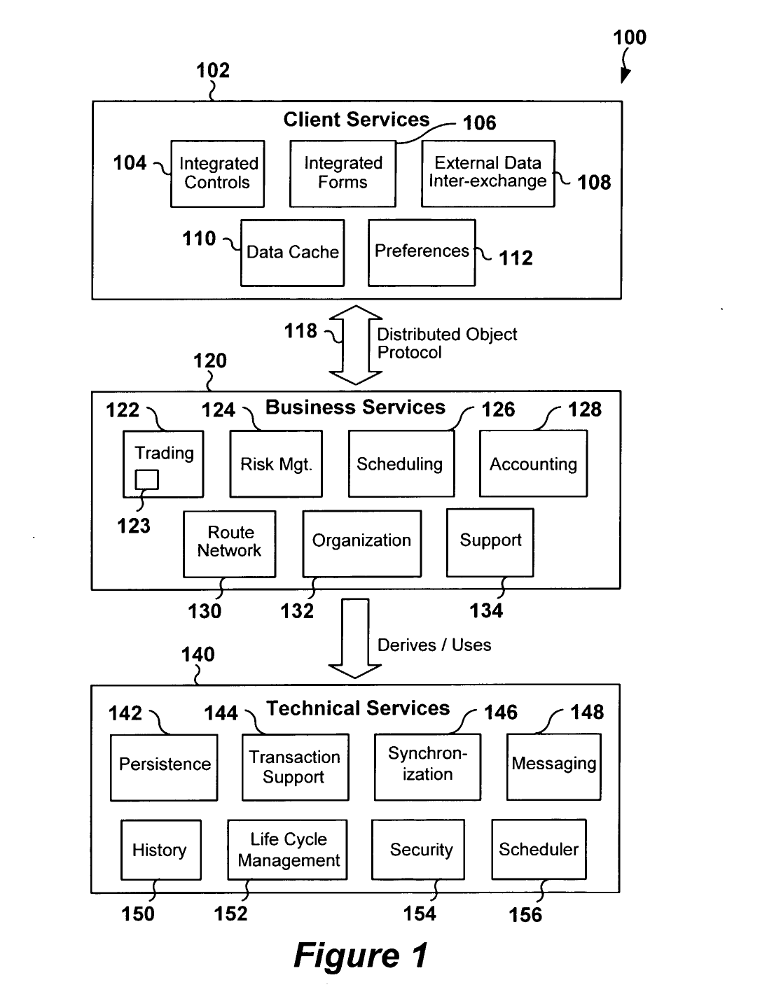

FIG. 1 illustrates the overall application architecture. Specifically, the client services 102 has an integrated controls interface 104, an integrated forms interface 106, an external data inter-exchange interface 108, a data cache 110, and a preferences interface 112. The various interfaces and caches of the client services 102 communicate with the business services 120 via distributed object protocol 118. The business services 120 contains a trading aspect 122, a risk management aspect 124, a scheduling aspect 126, an accounting aspect 128, a route network aspect 130, an organization aspect 132, and a support aspect 134. The business services 120 derive or use elements of the technical services 140. For example, the technical services 140 include persistence capability 142, transaction support services 144, synchronization module 146, messaging module 148, history module 150, life cycle management module 152, security module 154, and scheduler 156. The above-described architecture is illustrative of the present invention. However, alternate architectures that employ some or all of the functionality listed above may be employed without departing from the spirit of the present invention. Moreover, additional services may be added, or existing services removed, from the present invention with a corresponding increase or decrease in the scope of the system to accommodate owner requirements.

The objects, aspects, modules, interfaces and services of the system 100 of the present invention can utilize various communication protocols and standards. For example, object-to-object communication may employ COM, DOM, CORBA, SOAP, XML, or any other protocol or combinations of communication protocols and techniques. The specific communication protocol is not important to the present invention. Instead, it is the structure and arrangement of the objects within the business services layer 120 that enables the present invention to accommodate and implement business logic that mirrors, controls and/or mimics a real-life supply chain.

The object engine within the business services layer 120 of the present invention is structured in a way that enables the implementation of business logic associated with supply chains. Not only do the objects of the business services layer 120 implement the business logic, but they are structured in such a way as to be re-configurable to accommodate any business logic—even during execution of the business processes. This enables the present invention to reconfigure ongoing processes to reflect and accommodate changes in the structure and operation of supply chains.

The present invention consists of a set of objects that are unique in their construction as well as their configuration. Typically, objects enrich behavior in accumulative fashions by means of polymorphism as well as aggregation. This accretive nature has been enhanced in the objects of the present invention objects by careful consideration to maintaining the autonomy of individual objects as well as incremental feature growth in total. This allows the unique capability of the present invention to deliver multi-faceted behavior from various objects in different contexts. Moreover, it enables the objects of the present invention to present an emergent behavior of the complete supply chain for observation by operators or other processes.

Aggregate objects usually combine the behavior of “dependent” member objects. However, a “dependent” member object in the present invention would generally be architected to deliver the aggregate behavior that is desired in that particular application, yet be able to effectively reuse the same “dependent” object in an entirely independent context. For example, if an entity consists of a parent and multiple line items, those line items (dependents) would be constructed such that they could be accessed and used regardless of any “parent” association.

Architectural object autonomy as described herein translates into a remarkable ability to reuse by combining and modifying object properties (data) and behavior (methods) dynamically. Coupled with a strict compartmentalized insulation between the business logic (e.g., server) and the presentation (e.g., client) layers, this permits the application to present a virtually infinite combination of incarnations and configurations. For every possible combination or variance of data needs, a new user-interface form can be assembled to meet those specific needs. Such user-interface forms would be nothing more than a presentation channel in the purest form. The actual work—the business logic and processing—would be handled by one consistent set of core business objects. The use of a consistent set of core business objects of the present invention permits different individuals to work from their customized views and to use the data model to best suit their needs.

Ease of feature accrual by the present invention lends itself to unparalleled capabilities in terms of enhancements and upgrades. When users request new features, the same set of core business objects can be combined in different configurations in an easy manner to add the incremental feature sets, and thus deploy the revised application quickly and with minimal debugging. The synergistic approach afforded by the object architecture of the present invention is important to solving the supply chain management problem in a virtual-reality setting, because the objects are meant to model reality closely. The architecture of the objects of the present invention permits the arbitrary addition of features and modules with the utmost of ease. Not only is the end to end supply chain addressed, but the present invention is able to accommodate any business domain challenge with minimal enhancement to the core business objects.

The present invention provides tools that assist in the simulation of supply chain models and the monitoring of real-life supply chain operations. Some of the unique features of this system that differentiates it from other systems are described below.

Automated Two-Way Feedback

Typically, simulation systems of any operational business process provide a mechanism to analyze the results of a simulation based on hypothetical model parameters. Generally, there is no real-time feedback mechanism that allows, in an automated fashion, to input real-life operational-model parameters into the simulation model and integrate them with hypothetical-model parameters. In contrast, the system 100 of the present invention allows for analysis of simulation models within the context of supply chain using real-life operational data as well as user-defined hypothetical data. Additionally, when real-life operational data changes, the present invention enables those data changes to be reflected in the simulated business model.

Process Independence

The present invention recognizes that business processes change dynamically, based upon business conditions and evolving organizational constraints. The present invention encompasses a system 100 that allows for the specification and the customization of business processes for atomic units and groups of business tasks. The present invention does not force the business processes to change based upon the system's implementation. Rather, the present invention allows for dynamic application of business processes and respective business rules that govern the processes to units of business tasks.

Cross-Functional Independence

The present invention is designed for cross-functional independence within the context of a supply chain. The cross-functional independence afforded by the present invention allows for the deployment of business functional components that are independent of each other so that the components can be used in conjunction as well as in an independent, stand-alone functionality. In addition, specific processes within the business functional components are also independent under the present invention. The independent style of object architecture enables the implementation of flexible business rules, yet, enforcing them when specified. For example, contracts can be initiated even when trade negotiations are not finalized while the import of such a trade cascades to other depended business tasks (if any). However, if the contract is not executed in time, the propagated impact is rolled back to the pre-implementation state.

Cross-Functional Integration

The present invention integrates with other inter/intra/extra-organizational business functions in order to ensure that changes in depended data are automatically reflected in user functions. Moreover, changes are validated based on user-defined business rules per atomic business tasks.

Integrating “Corridor” Conversations with Business Data

The present invention supports persistence and integration of any ad-hoc operational conversations that may impact one or more business units. The preferred embodiment of the system 100 of the present invention provides a communication interface that allows users to communicate and to share unformatted operational data. The communication interface of the present invention allows users to capture and to analyze business transactions that are based on both structured and unstructured data. Further, the communications associated with the business transactions can be attached to business tasks data for ready reference.

The architecture of the object engine of the present invention is capable of substantial rearrangement of both properties, methods, and organizational structure without departing from the ability to implement the business logic in a consistent manner, and to accommodate changes to that business logic in a dynamic manner. A detailed description of an illustrative embodiment of the system 100 of the present invention is provided below. It should be noted that numerous alternate embodiments of the present invention are possible, and that the following description is not meant to indicate an exhaustive list of possible equivalents that are within the scope and spirit of the present invention.

2. Technical Services

Overview

Technical services 140 include infrastructure support for the business services 120 and the client services 102. The overall system 100 is designed and engineered to interface with any system that will provide the facilities and functions that are provided by the technical services components 142-156. Some of the services that are provided by the technical services layer are as follows:

Persistence module 142 provides the functionality to save data for the business layer 120 and the client layer 102. The persistence module 142 can interface with any commercial relational database and enable the data to persist indefinitely. Additionally, the persistence module 142 preferably supports customizable query and editing functions.

Transaction Support module 144 provides support for transactions that are committed by the objects of the business layer 120. Transaction support preferably includes concurrency, consistency and integrity of the data.

Synchronization module 146 provides the synchronization of related data in order to represent a consistent view to the user. Transaction changes can cause cascading modification to other related object data. The synchronization module 146 ensures that transaction changes are applied in a consistent and timely manner.

Messaging module 148 provides infrastructure for notification delivery, message exchange, persistence, and tracking of messages over the communication network. The service provided by messaging module 148 is important because it supports the integration of real-time operational and system conversation.

History module 150 maintains object properties through the complete life cycle of the object. The services of the history module 150 can be configured such that only those properties and objects that are of historical importance are maintained.

Life Cycle Management module 152 provides services to manage the life cycle of objects within the system 100 of the present invention. Actions and methods that have to be executed before or after an object's life, or when changes are made to the object, can be specified within the life cycle management module 152. The life cycle management module 152 ensures that object actions are automatically executed based on life cycle parameters.

Security module 154 ensures that only valid client objects are allowed to change another object's data or to execute a method or action.

Scheduler module 156 provides a mechanism for setting the execution of scheduled server processes. The scheduled server processes are typically set and defined by business objects of the business layer 120. The scheduler module 156 improves efficiency of the system 100 by deferring processing to off peak times.

In order to achieve these goals effectively, the system 100 employs an open-system infrastructure that is constructed from layers of cooperating components. Each of the components and modules within each of the layers is specifically designed to accomplish its particular objectives.

Description of the Services within the Technical Layer

Messaging

Schedulers, Traders and other business entities communicate with each other during the deal capture and management process. These communications are generally unplanned and ad-hoc. However, they are important because they clarify and resolve issues between the parties. The messaging module 148 provides an electronic forum for “conversations” and delivery of notifications between objects that act as parties to a transaction. The messaging module 148 provides the following services:

Persistence: Messages or “conversations” between participants are logged in to the persistence module 142. Messages can be made to persist for a configurable number of periods. The persistence feature provides the user the ability to retrieve archived messages.

Filtering: Users can define filters that will automatically filter messages. This prevents the user's display from being clogged with messages and allows them to view or participate in “conversations” of particular interest. The users can set filters at various levels by type, sender or group.

Notifications: The messaging service is used by other business functions such as Trading 122, Scheduling 126, etc. in order to broadcast messages and notifications. For example, a trading object 122 interfaces with a scheduler object 124 that can automatically schedule the delivery of bulk messages during the off-peak usage time. The automatic scheduling capability conserves communication network resources during peak time-periods, and precludes the need to interrupt the user during peak work time. The automatic scheduling greatly increases the computing efficiency, as well as labor efficiency, of the system 100 of the present invention.

User Customizations: The user can customize the message delivery mechanism. The user can set filters, display options, subscribe to messages, etc. However, the system 100 does not users to filter system or administrative messages to ensure that all users receive important messages.

Group Memberships: The administrator of the messaging service 148 sets the user's profile and membership to groups. The system 100 allows for the definition and attachment of customizable rules for enforcing group memberships and policies.

3. Business Services

Overview

The business services layer 120 contains the set of objects (the object engine) that implement the business logic of the supply chain. Various aspects of the object engine are exposed to the interfaces of the client services layer 102. Similarly, the objects of the business services layer derive services from the technical services layer 140. The object engine itself is a complete set of objects, but has discernable aspects that are amenable to identification. It should be noted, however, that the object engine within the business services layer 120 are a unified whole, and are not intended to be segregated. Segregating the objects within the business services layer 120 would impede the seamless integration of services that provide a serendipitous increase in performance over the disjoint systems of the prior art.

Trading

The trading aspect 122 provides full life cycle support for contract capture and generation. Embedded business logic is used for validation. The trading aspect 122 enforces business rules for contract approval process, yet the process itself can be configured to meet dynamic changes in a business environment. The trading aspect 122 supports the operational business processes by capturing trading data, and by maintaining the consistency and the integrity of that data across a distributed communication network. The trading aspect 122 also realizes the real-life situations of contract negotiations where contracts, once executed, may be modified or amended and those modifications or amendments prompt a separate cascade of changes throughout the system for such issues as Scheduling, Pricing, etc. Ease of data capture, flexibility, customizable intelligent user interface, and role-based security scheme, are the important features of the overall trading system.

Scheduling

The scheduling aspect 126 provides a suite of objects for the planning, the optimization, the tracking, the execution and the reporting of the movement of goods or commodities. The objects of the scheduling aspect 126 also provide the resulting dynamic positions and inventories throughout a route network from the time and place of purchase or acquisition to that of sale or distribution. The multi-user environment allows for a common and integrated data source which is populated with pertinent and timely information collected from the numerous individuals and the electronic data feeds that are typically involved in the scheduling process. The scheduling aspect 126 provides a highly efficient scheduling environment by simplifying and automating common tasks, including: generating and manipulating numerous records with a single user action; performing lengthy calculations, such as position and inventory; generating reports and distributing those reports electronically to internal or external parties; and maintaining the consistency and the integrity of large amounts of data.

Accounting

The accounting aspect 128 integrates with the trading aspect 122, the scheduling aspect 126, and other aspects of the business services layer 120 to derive and to manage accounts that are associated with managerial and financial accounting functions. The accounting aspect 128 may also interface with other processes, such as other accounting systems, that are external to the system 100 of the present invention. The goal of the accounting aspect 128 is to support planning, control, decision-making, and regulatory compliance activities as well as to generate financial entries into the user's financial accounting system. Financial statements or reports that are generated by the accounting aspect 128 are fed into other organizational accounting systems that are either internal or external to the system 100 of the present invention. Among other aspects, the accounting aspect 128 determines credit exposure, allocates premiums and discounts, generates the cost of supply, determines and books voyage, barge, rail, and truck, pipeline gains/losses, tracks exchange balances, generates invoices and notifications, etc. The system 100 of the present invention also supports the determination of forecasted cash receipts and disbursements. These various debits and credits are then used by the system 100 of the present invention to better estimate real-world costs, risks, and exposure.

Risk Management and Measurement

The risk management and measurement aspect 124 integrates with the physical trading aspect 122, the scheduling aspect 126, and the accounting aspect 128. Alternatively, the risk management aspect 124 could stand alone for pure trading activity. The risk management aspect 124 provides full life cycle support for deal capture, deal generation, and deal valuation utilizing embedded business logic that can be used to validate the deal. The risk management aspect 128 enforces business rules for the deal approval process, yet the deal approval process itself can be configured to meet dynamic changes in the business environment. The risk management aspect 128 supports the financial and the operational business processes by capturing trading data, maintaining the consistency and the integrity of data across at least one distributed communication network. All financial instrument types are captured by the present invention, including, but not limited to: swaps, basis swap, exchange futures, exchange futures options and over-the-counter options. Additionally, the present invention may also capture combination physical/financial instruments. Physical and financial positions are provided in any timeframe needed for decision making and financial reporting. The system includes market data in the form of a repository that maintains and tracks the latest market data for different commodities from various exchanges, publications and/or internally derived. The data can be viewed independently or referenced in a price formula for forward curves. Interest rates, volatility and other market data.

Route Network

The route network utility system 130 provides a suite of objects of general capability having no related or associated intent beyond that of support and reuse by other business and client service layer systems. The route network system 130 objects are designed to provide lightweight, standalone functional services.

Organization

The Organization function 132 within the business services 120 provides the capability to model organizational hierarchy within a company that interact with other business functions such as Trading 122, Scheduling 126, Accounting 128, etc. This allows for simulation of real life operation interactions of individuals and their business functions. The model components are configurable such that the temporal nature of job positions and person(s) fulfilling those positions can be modified easily. The organizational model simulates the abstract relationships between its constituents and integrates with other business functions

Description

Trading

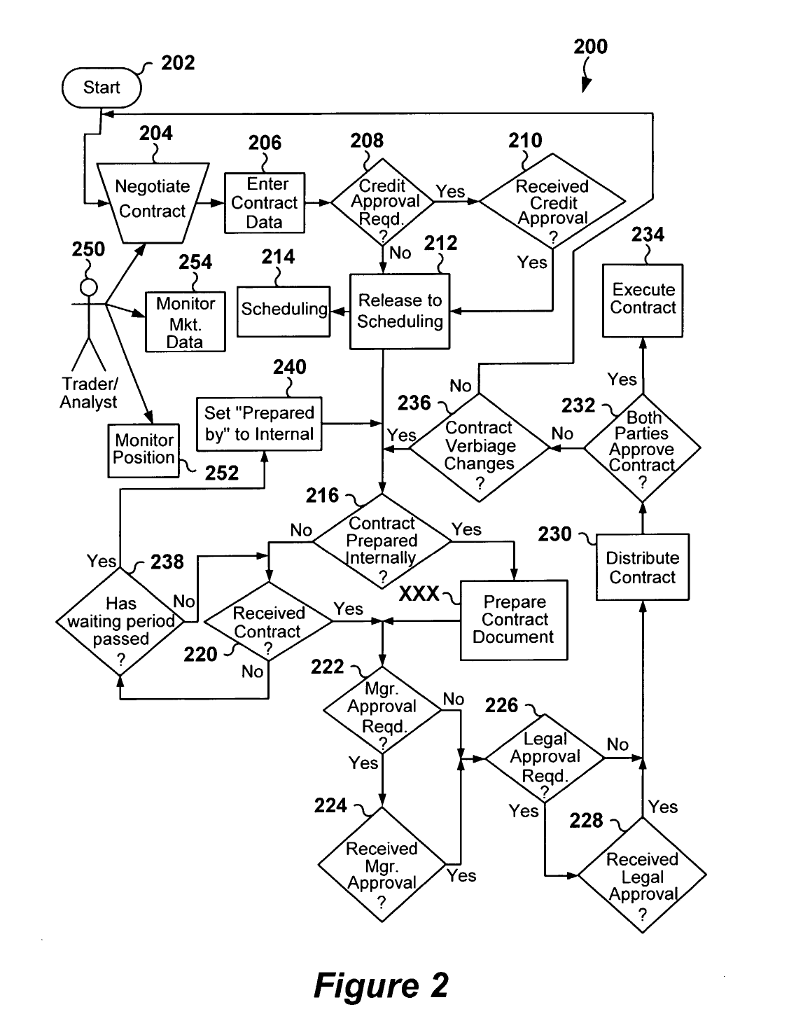

FIG. 2 illustrates one common overall trading business process. Traders and analysts monitor external (market data) and internal (positions) as inputs to develop a strategy for commodity trades. Using that strategy, the trader initiates contract with other traders in the market. After the initial contact, a negotiation process that culminates in a “trade”. The present invention is structure in a way that accommodate the multitude of possible outcomes in contract negotiations. For example, the present invention can accommodate situations where the contract is not negotiated on the first try, and has to be modified and resubmitted multiple times. Should a trade result, the trader then captures all of the trade-related data in the system 100 of the present invention. If the trade includes a sale of a commodity, the system automatically interfaces with an internal or external credit approval process (that is available via the external data exchange interface 108) that displays credit and other related information about the other partyother party. The combination of the above strategy, and credit and commodity pricing (“REFER”) information, enables the trader to proceed with the trade or make modifications and/or renegotiate the contract. Note, the present invention is able to accommodate a human trader, as well as utilize an autonomous or semi-autonomous object or set of objects that represent a trader.

Once the credit for the trade is approved, the specific trade is persisted but not released to the scheduling aspect 126. However, if the trader determines that all of the relevant data pertaining to the commodity that was purchased was captured, then the contract is “released” to the scheduling aspect 126 for scheduling of the commodities through the route network 130. At this point in the life cycle, the trade is complete and the related contract data is captured in the system 100 of the present invention. However, the contract is not yet executed.

The contract will be both generated and distributed either by the party or by the other party. When the contract is to be prepared internally, the traders and the contract administrators use a contract generation tool 123 that allows them to add pre-defined or new legal content to the contract data. The contract generation tool 123 allows the users to generate any type of contract and apply business rules for approval processes. The contract generation tool 123 enables the users to create contracts by using one standard interface. During the life cycle management of the contract, other types of contracts, such as transportation contracts, can also be generated using the contract generation tool 123. It should be noted that the contract generation tool 123 may not need to reside within the trading aspect 122. Contract generation is a fairly generic necessity. If properly implemented, the contract generation tool 123 can reside in, for example, the technical services layer 140. Moreover, the contract generation tool 122 can be enabled to assemble any type of contract, and is not intended to be restricted to generating contracts for commodity trading. For example, transportation contracts are independent of commodity trading, yet, with the right data input from the transportation objects, a suitable contract can be generated. Additionally, unique approval requirements including approvals from Legal office, Traders, Schedulers, Contract Administrators, Managers, Title, and Contracts office can be specified on a per contract basis.

The contract document generation, and the process of approvals, may involve several iterations before the contract is finalized and sent to the other party for final execution. The system 100 of the present invention tracks the changes to the contract document made during each iteration. After the contract is sent for execution, the other party may want to make modifications to either the verbiage or the terms of the contract. The contract generation tool 123 is used to make modifications to the contract document, which may require approval from managers and legal office. When both parties approve the contract, the contract is then executed.

In the scenario where the contract is to be prepared by the other party, both parties agree to the number of days (the “waiting period”) within which the first party will receive the contract from the other party. The system 100 of the present invention tracks the receipt of the contract documents from the other party. If a contract document has not been received, and the waiting period has expired, then appropriate notifications are automatically sent to the involved parties by the system 100 of the present invention. Under these circumstance the party may decide to assume the responsibility of preparing the contract documents. The present invention provides the ability to dynamically switch the responsibility of preparing contracts between the party (internal) and other party (external) before or during negotiation. This switching is accompanied by the enforcement of respective business approval processes for a specific contract by the system 100 of the present invention.

Another feature of the trading aspect 122 is real-time communication between individuals and the system 100 using the supporting communication network. The messaging service (“REFER”) 148 is used to capture, persist and track any and all ad-hoc “conversations” that make up a final trade. Additionally, when changes are made, notifications are distributed proactively by the system to specific individual roles for action and/or for information.

A more detailed description of the trading method 200 of the present invention is illustrated in FIG. 2. The method starts generally at step 202. Thereafter, in step 204, the contract is negotiated. Once the contract has been negotiated, the contract data is entered into the system 100 of the present invention in step 206. Next, in step 208, a check is made to determine if credit approval is required for the specific contract in question. If credit approval is required (i.e., the result of step 208 is positive), then credit approval is sought and, in step 210, a check is made to determine whether such approval has been received. If credit approval has been received, or if credit approval is not required (i.e., the result of step 208 is negative), then step 212 is executed, wherein the contract is released to scheduling. At this point, the method splits into a parallel process, namely steps 214 and 216. In step 214, the process of scheduling the commodities (or other goods and services) is started, as well as the updating of inventory levels, etc. The present invention facilitates the concurrent processing of business processes. The system 100 of the present invention improves operational efficiencies by allowing business processes to occur concurrently, even if there are rules governing the sequence of the steps making up the particular process. For example, in case the contract is not generated or not executed, the impact on other systems (such as scheduling) is communicated to the affected objects, and updates to, for example, the inventory level and scheduling operations are made.

At the same time that the contract has been released to scheduling, execution of the method 200 moves to step 216, wherein a check is made to determine if the contract is to be prepared internally. If so, then the contract is prepared in step 218. If the contract was not to be prepared internally, i.e., the result of step 216 is negative, then a check is made in step 220 to determine if the contract has been received from the other party. If the contract has not been received, i.e., the result of step 220 is negative, then a check is made in step 238 to determine if a user-defined waiting period has expired. If the waiting period has not expired, then execution loops back to step 220, otherwise, execution moves to step 240 and the contract is designated to be prepared internally and execution moves back to step 216 for further processing.

If the contract has been received (i.e., the result of step 220 is positive), or if the contact document has been prepared in step 218, then execution moves to step 222, where a check is made to determine if manager approval is required. If manager approval is required, then execution moves to step 224, where a check is made to determine whether manager approval has been obtained. If manager approval is not required (i.e., the result of step 222 is negative), or if manager approval has been received (i.e., the result of step 224 is positive), then execution moves to step 226, where a check is made to determine whether or not legal approval is required. If legal approval (e.g., by a lawyer and/or government regulatory) is required, the execution is moved to step 228, where a check is made to determine if legal approval has been received. If legal approval has been received (i.e., the result of step 228 is positive), or if the result of step 226 is negative, then execution moves to step 230, wherein the contract is distributed to both parties. Thereafter, in step 232, a check is made to determine if both parties have approved of the contract. If so, then the contract is executed at step 234 and the method ends generally. However, if the contract has not been approved by both parties (i.e., the result of step 232 is negative), then execution moves to step 236, wherein a check is made to determine if changes are needed in the verbiage of the contract. If changes to the verbiage are required, then execution moves back to step 216. Otherwise, i.e., the result of step 236 is negative, then execution moves back to the negotiation stage of step 204, as illustrated in FIG. 2.

FIG. 2 also illustrates some of the activities of the trader/analyst 250. In addition to monitoring or participating in the negotiation of the contract, the trader 250 may also monitor market data (step 254) and monitor positions (step 252) either sequentially, or in parallel with the negotiation of the contract.

Trading Business Model

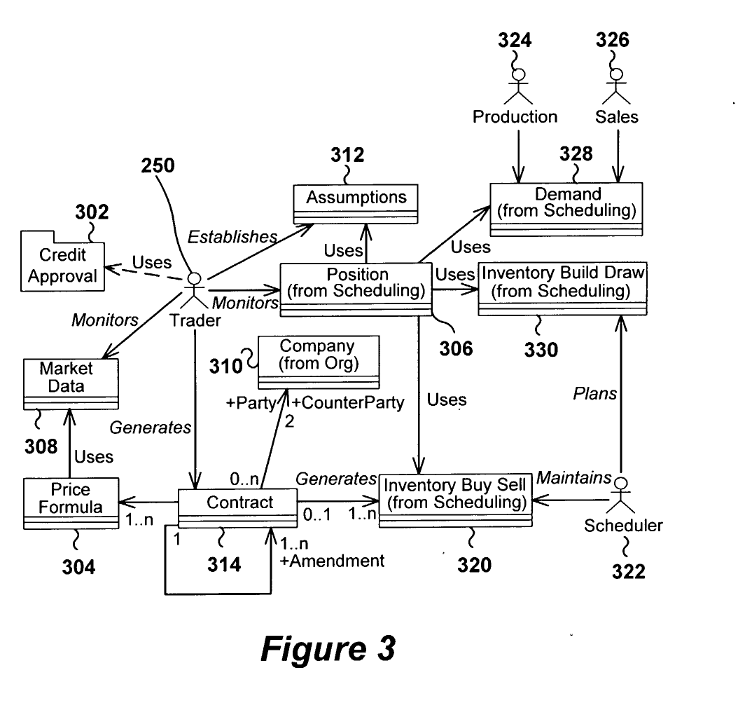

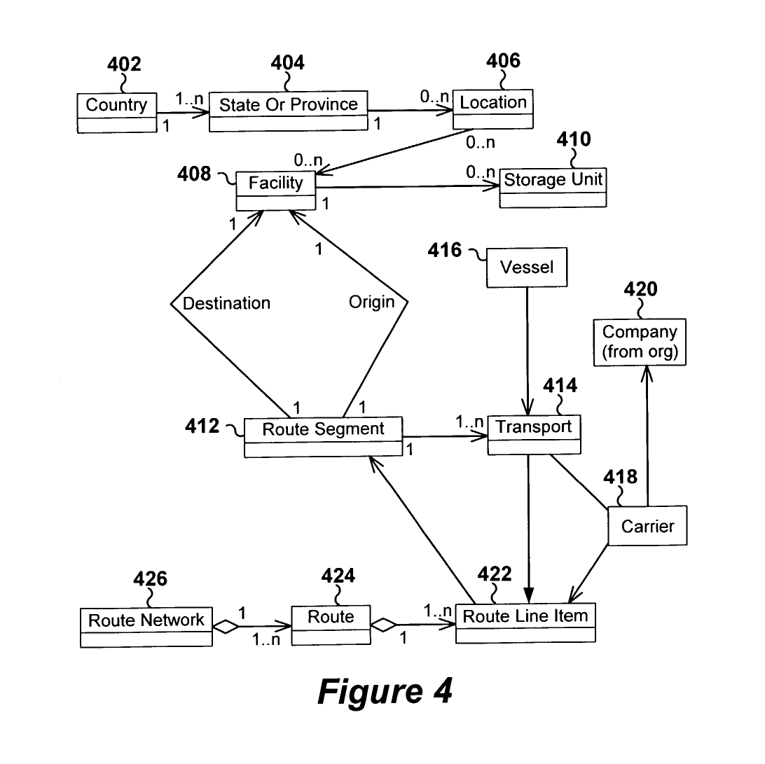

FIG. 3 illustrates the trading business model 300 and its relationship to other functions. The trading business method uses the credit approval system 302 in conjunction with pricing formulas object 304, positions objects 306, market data objects 308 and assumptions objects 312, in order to negotiate trades with other parties. Trade volumes and negotiations are finalized, based on integrated comprehensive information. The system 100 of the present invention provides multi dimensional views of data to assist the trader 250 in formulating appropriate and efficient trades. It should be noted that some of the objects mentioned above can be generated dynamically. For example, the positions object 306 can be a derived value from the scheduling aspect 126 that is calculated in real-time based on changes in inventories. Moreover, even thought the responsibility for calculating positions might rest with the facility object 408 (see FIG. 4), the system 100 of the present invention presents a multi-dimensional view of positions to users, based on a variety of factors such as location, commodity, etc. Other objects can be similarly generated dynamically to provide information to users and/or other processes, based on information kept within the present invention, and/or received by the present invention.

Other elements of the trading business model 300 are illustrated in the example model of FIG. 3. For example, the trader generates one or more contract objects 314. The contract object 314 can contain properties that distinguish the terms of one contract from another. The contract object 314 may also have methods that can be used to mimic the execution of the contract (by performing the services called for by the contract. The contract object 314 may also have relationships with other objects, such as the price formula object 304, the inventory buy/sell object 320 (that is normally part of the scheduling aspect 126), and the company object 310. Similarly, the inventory buy/sell object 320, which is maintained by the scheduler 322, has a relationship with the position object 306 (also part of the scheduling aspect 126). The position object 320, in turn, has relationships with the demand object 328 and the inventory build/draw object 330 (both of which are part of the scheduling aspect 126), The one or more demand objects 328 receive input from the production actors 324 and/or from the sales actor 326. The inventory build/draw object 330 also receives plans from the scheduler 322. All of the actors of the present invention, such as trader 250, scheduler 322, production 324, and sales 326, can be human operators and/or virtual processes that either autonomously, or semi-autonomously operate in the same capacity as the human operator. The autonomous or semi-autonomous processes can receive input directly from real-world sources in real-time, or they may respond to a pre-defined algorithm or set of data, such as a recorded set of parameters used for subsequent analysis.

The automated process 300 of the present invention enables the capture of contract data in real-time and also checks for the validity of contract data (e.g., the properties of the contract object 314), preferably based on domain specific rules. Flexibility is built into the system 100 of the present invention to accommodate exceptions. The automated process ensures capture of complete, accurate and consistent data. Modifications to the data, such as canceling or deleting a contract, are allowed and are based on integrated business rules. The contract capture data can then be shared among other processes within the overall context of trading, contract generation and scheduling. Captured contracts can then be viewed in a consolidated, comprehensive display. Additionally, the process 300 of the present invention allows for the capture of a contract in a phased manner over multiple times by providing the capability of “releasing” a contract. Only when the originator trader 250 releases a contract the contract is available for contract generation, execution, and sharing with other business system processes.

The trader 250 may work with many contracts, that are preferably all similar in content. The trader 250 typically wants to clone an existing contract rather than create a contract from scratch. However, there are always certain contract information elements that are unique to a contract and they will need to be captured. Cloning a contract will add to the efficiency of the contract capture process. The cloning process ensures that no inconsistencies or inaccuracies exist between contracts that are cloned. The cloned and the original contract are treated as separate contracts. However, pre-defined or dynamic business rules for validation are applied in the same manner as for the original source contract. The cloning logic allows for copying of the data from an existing contract to a new contract. However, certain contract information is not copied and the trader has to capture that information.

After a contract is captured, the contract can be edited, cancelled or amended. When changes are made to a contract the automated process ensures contract information consistency and optimizes enabling of changes.

A contract can be cancelled based on specific business reasons. Additionally, changes can be made to the contract and an amended contract is generated. A cancelled contract automatically results in a notification to the external parties. Additionally, notifications should be sent to entities within the organization so that one or more appropriate business steps could be initiated due to the changes or cancellation of a contract.

The system 100 of the present invention allows contracts to be edited, cancelled or amended. However, enabling of certain functions is dynamically set in real-time based upon business rules that pertain to that stage of the business process. For example, a contract that is already executed cannot be amended or modified without taking some other business steps. The intelligent checking and validation changes in real time ensure that business processes are strictly adhered.

In the preferred embodiment, traders would be able to determine quickly and easily whether the trader is long or short for any given commodity by examining the position. If short, the trader knows additional quantities must be purchased. If long, the trader knows additional quantities must be sold. Traders get this information by executing the position calculation. Reference can also be made to the corresponding position calculation for the scheduler. Note, receipts, deliveries, and inventory information results in a position. Schedulers apply one or more build or draw transactions, which are planned activities rather than an actual physical transfer of commodity, to obtain an effective position for schedulers. The traders then refer to the position as ascertained by the actual transactions as well as the schedulers' projected and planned transactions, along with production and demand (actual and forecast) in order to do their planning activities.

Traders or analysts enter plans to exchange commodities rather than execute a pure or outright purchase or sale. Handling exchanges are an essential element of the position calculation (refer scheduling position).

When one party agrees to sell or exchange a commodity to another party, the agreed upon price may be a simple fixed and flat value, or a complex, event based, formula involving many components. Many people require the ability to view and calculate prices e.g.: traders, schedulers, cost accounting, analysts (i.e., credit, economic, risk management, financial), operations coordinators, billing, and contract administrators.

The pricing aspect provides the capabilities to research historical pricing, input simple and complex pricing formulas, calculate the formula at a given point in time, utilize (i.e., in contracts, commodity valuation) and report the results. The system includes market data in the form of a repository that maintains and tracks the latest market data for different commodities from various exchanges. The data can be viewed independently or referenced in a price formula. Further pricing formulae in the form of libraries are supported to facilitate a price formula and enable reuse.

Trading business functions interface with the user's organizational structure to determine the roles of individuals who participate in the formulation of a trade. Trading business functions thus ensures that individual responsibilities are properly tracked and operational snags can be routed to the right individuals for resolution.

Route Network

FIG. 4 illustrates the route network model. Route network is an abstract collection of the Routes class of objects. This abstract collection allows the system 100 of the present invention to present a subset of routes that are based on user preferences, roles and security. Members of the Routes class may have one or more of the following properties or contain object instances of one of the classes described below. As with other object sets of the present invention, the objects of the route network can contain properties and methods. The properties can be either global, or local to the particular object. Moreover, the properties need not reside in any particular object, but may be rearranged for placement in other objects, or within one of the layers mentioned previously as a service for any process or sub-process of the present invention.

Objects of the present invention may be equipped with methods that provide a convenient way to manipulate information, such as property values, within the object (or global properties). The methods of the various objects may be called by the system 100 of the present invention and/or by object instances contained within, or external to, the system 100 of the present invention. The capability provides for the creation of a virtual environment within the system 100 of the present invention, wherein object instances can communicate with one another, or with external processes and devices, in order to enable those object instances to operate autonomously, in conjunction with other objects and processes, and/or under the direction of another process or object to form a complex adaptive system.

An example of the route network model 400 of the present invention is illustrated in FIG. 4. Central to this example of the route network model 400 is the route segment object 412. The route segment object 412 can obtain an origin and/or a destination from a facility object 408. The facility object 408 has a relationship with the storage unit object 410, and the location object 406. The location object 406, in turn, has a relationship with the state or province object 404 which, in turn, has a relationship with the country object 402.

The route segment object 412 also has a relationship with the transport object 414 and the route line item object 422. The route line item object 422 has a relationship with the route object 424 which, in turn, has a relationship with the route network object 426 as illustrated in FIG. 4. The transport object 414 has a relationship with the route line item object 422, the carrier object 418 and, for example, the vessel object 416. The carrier object 418 has additional relationships with the route line item object 422 and the company object 310 of FIG. 3.

Country

A country represents a recognized nation or political division of land, which needs to be tracked in the system (e.g., United States of America or Canada).

State or Province

A StateOrProvince property represents a recognized division within a country (e.g., Texas or Quebec). In some cases when a specific division of a country does not exist or is irrelevant to information requirements, the country's name is repeated for the state or province. This flexibility enables capturing only relevant data without enforcing geographical restrictions.

Location

A Location represents any abstract geographical location such as a city or an area in the Gulf Coast. Examples include Catlettsburg, Columbus, and South Pass Block 87. Location object is used for filtering facilities in the view. The Location properties are used primarily as identification points for tracking the supply and demand of a commodity and do not necessarily correspond to a physical location.

Facility

A Facility represents a physical site such, as a refinery or terminal. A value for the facility property generally indicates that a supply or demand for a commodity exists. A facility may span multiple locations and a location may contain multiple facilities or a single facility. A facility may contain multiple storage units and a single storage unit may span multiple facilities.

Storage Unit

A Storage unit represents a specific container (e.g., a tank, cavern, truck, or even a pipeline itself) that holds a commodity. The storage unit may or may not represent a physical entity within the transportation network. The system 100 of the present invention enables the user to include a virtual storage unit for planning purposes and review its impact on the overall plan. Later, an actual physical storage unit can be added or another storage unit reassigned to a facility. The system 100 of the present invention may include a multi-dimensional user view that is designed to display all of the information for location, facility, and storage unit combinations and permutations.

Route Segment

A RouteSegment is the smallest “trackable” segment that a transport mechanism can move a commodity from “point A to point B”. The route either does not split or join up with any other between the origin and destination points, or the user may simply not care to represent it. A RouteSegment is a valid, single-legged combination of a specific origin facility to a destination facility. A RouteSegment is directional.

Transport

A Transport is a physical mechanism by which a commodity is moved from point A to point B. The Transport has properties that identify various types of transport mechanisms. A Transport acts inherently as a storage container with the capability to transport a commodity. The system 100 of the present invention allows the modeling of any transportation type because the Transport contains commodity inventories that should to be included in the inventory calculations. A transport object may represent an actual pipeline, ship, barge, rail car, truck, or any other commodity transport vessel. The system 100 of the present invention enables the user to customize the level of detail used to record the movements of the transport object that represents the real world transportation mechanism. In addition, the transport object may be fitted with properties and methods that detail the capabilities of the transportation mechanism being modeled. For example, a “move” method could be added to the transport object that may receive a command to “move” the commodity being transported to a particular set of coordinates. The transport object of the present invention may thus contain objects that represent commodities and, on their behalf, deliver them to another location (i.e., change their respective location properties to indicate the new location of the commodity (either the actual location, or, in the case of an optimization model, a virtual location). The transport object can be equipped with logic that enables the transport object to find its own way to the specified destination, which would help decentralize management, provide for a more robust system, and enable autonomous optimization of the supply chain.

Vessel

Vessel is a specific type of transport. Additional information is maintained about the vessel (i.e., dead weight tonnage).

Carrier

A Carrier is a specific kind of company responsible for transporting commodities.

RouteLineItem

The Transportation network comprises of collection of route segments. A route between two pints can be designed using alternate paths. Additionally, each route segment could be part of multiple routes. The Route Line Item object sequences one or more route segments into a larger route concept. Note, the order of the route segments is significant. This system allows customization of route segments into a route during planning phase. For example, if “A to D” represents the route, then the underlying route segments might be specified as “A to B”, “B to C”, and finally “C to D”. Similarly, the route “A to D via B2” might use route segments “A to B”, “B to B2”, “B2 to C”, and “C to D”. Although the origins and destinations of these two examples were the same, the route was composed of a different set of route segments.

Route

Route is a user-named representation of an origin and destination pairing. Normally, the movement of a commodity from this origin and destination must traverse multiple route segments. The use of routes provides efficiencies for the user in creating movements that often times traverse the same sequence of route segments repeatedly.

Organization

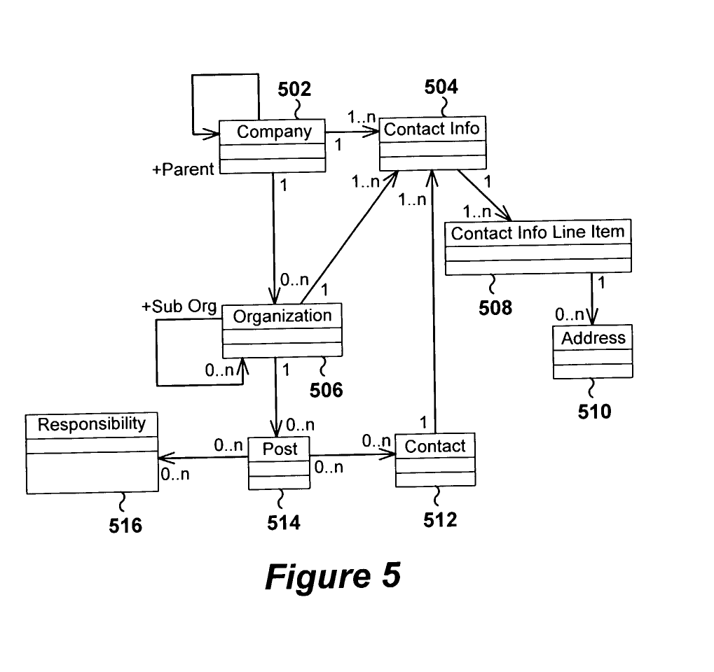

FIG. 5 describes the model of organization function 500. An organization is persisted in the system as interacting and communicating objects of the type Company, Organization, Contact(s), Contact Info, Post and associated Responsibilities.

Referring to FIG. 5, the model 500 has a company object 502 that has a relationship with one or more contact info objects 504, and relationships with zero or more organization objects 506. A particular organization object 506 has additional relationship with the zero or more post object 514 and one or more contact info objects 504. The zero or more post objects 514 have relationships with zero or more responsibility objects 516 and zero or more contact objects 512. A particular contact object 512 has a relationship with one or more contact info objects 504. A particular contact info object 504 has a relationship with one or more contact info line item objects 508. A particular contact info line item object 508 has a relationship with zero or more address objects 510.

Company

The company object comprises of data and behaviors pertaining to different types of companies, such as an internal or an external company, and any associated parent company. The company object contains contact information needed to keep track of a company's mailing, billing and/or invoicing information. The Company object can also comprise other organizations. The recursive relationship between Company and Organization objects provides the ability to scale the model as organizations grow.

Organization

An organization is used to model the hierarchy of groups within a company. The organization object has properties that are used to specify the type of organization. Example organization types include department, section, region, etc. An organization can have sub-organizations and sub-organizations may themselves have sub-organizations.

The organization object enforces rules that restrict the relationships between the various types of organizations. For example, a department may consist of sections but sections cannot contain departments. These business rules are configurable based on real life hierarchical parental relationships between organizations and sub-organizations. Additionally, the organization object independent of its parent company or organization contains specific contact information.

ContactInfo

The ContactInfo object keeps track of all means of communicating other entities, which could be a person, company or organization. It is a general concept that applies to more than just individuals (people), companies and organizations. ContactInfo object encapsulates all contact information for an entity. ContactInfo object can include email addresses, telephone numbers, mobile telephone numbers, pager, facsimile numbers, telex addresses, physical and mailing addresses, and/or web URLs or other contact information. For example, a person's work and home contact information are saved in a single ContactInfo object. The ContactInfo object contains one line item for each set of contact information.

The system 100 of the present invention provides the flexibility to inter-link specific elements of information such that related contact information elements can be retrieved easily. However, the system 100 does not enforce dependencies. For example, an address can be captured without specifying a telephone number or vice-versa. This type of flexibility allows information to be captured, as it is available or even when it is incomplete, to be completed later as it is made available.

Address

This system treats the Address object independent of its ‘owner’. The address can be of varying formats based on location and other parameters.

Contact

The contact object is used to keep track of people within a company, organization or sub-organization. Each contact object is associated with respective contact information.

A contact is assigned to fill one or more posts Cob position) within a company organization. This allows the flexibility to keep the organization structure persistent and not change with the changing membership of individual participants.

Post

A post is used to define the job positions within an organization. This could be a trading desk or a specific scheduling job within an organization. Posts are filled by contacts (people) and a record of each contact's start date is maintained so that the system can identify who filled the post at any given time. The type of post is called the role. Examples of roles are: trader, scheduler, accountant, etc. The role is a general type of position while the post is a specific job position. A post contains a collection of responsibilities. That is the user can specify which location/facility and commodity combinations this job position is responsible for.

Contacts are not directly mapped to a company. Instead, contacts are mapped to a post within an organization that belongs to a company. The model is implemented in such a way that only a single organization and post need be used to keep track of all of the people within a company. In addition, the objects of the present invention support a method to add a contact to a company without having to associate a post.

The model of associating individuals with posts provides a user the ability to model situations where the post will not change but the person filling the post will change. In addition, a given post may have a multiple number of responsibilities. For example, trading desks may be responsible for certain combinations of location, facility and commodity. The system 100 of the present invention makes it easy to reassign the post to another person rather than having to reassign each of those responsibilities to another person directly.

Support

Units

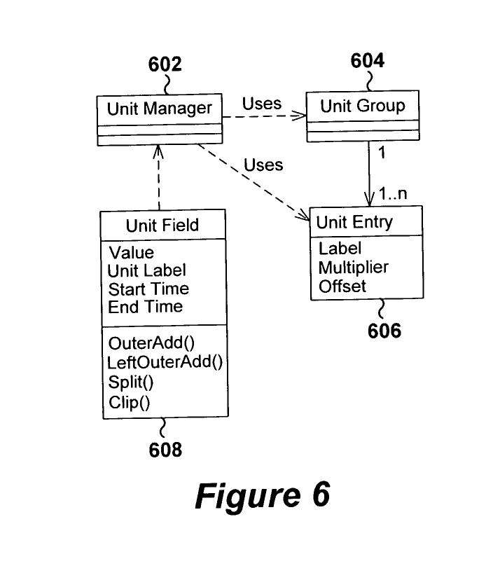

The units system provides a set of objects for conversion of numeric values from one unit to another. FIG. 6 shows the class diagram 600 for the units system.

The class diagram 600 for the units system (part of the support aspect 134 of the business services layer 120 illustrated in FIG. 1) includes the unit manager 602 which uses the unit group 604 and the unit entry object 606. A particular unit group object 604 has a relationship with one or more unit entry objects 606. The unit field object 608 has relationship with the unit manager 602.

The objects include the UnitGroup, UnitEntry. and UnitManager. The UnitGroup defines groups of related units such as length, volume, mass, time, and temperature. The UnitEntry object represents specific units such as feet, meters, pounds, seconds and degrees Celsius. Every UnitEntry belongs to one and only one UnitGroup., Each UnitEntry object maintains a multiplier and an offset that, when applied by a unit manager, can be used to convert from one unit to another.

The units system is flexible in that unit groups and entries are maintained in the data store and can be dynamically added, modified or removed at any time. The UnitManager is responsible for reading, updating and otherwise maintaining the unit definitions in the data store and for carrying out the actual conversions. The unit system also provides the UnitField object, which represents a value, unit, start and end time and encapsulates logic for combination with other UnitField objects using simple arithmetic operations without requiring the user of the UnitField objects to be concerned with the unit conversion process. The arithmetic operations that are available to the UnitFile object include, but are not limited to, adding, clipping, splitting and joining based on the start and end times specified.

Scheduling

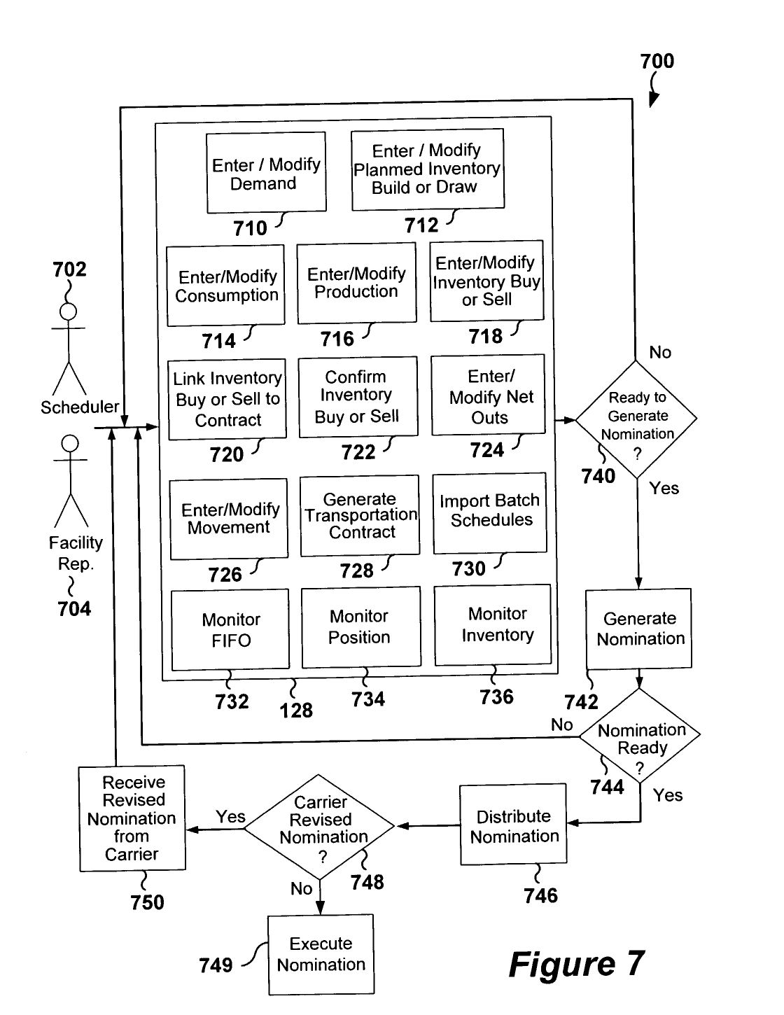

FIG. 7 illustrates the overall scheduling business process of the present invention. The system 100 of the present invention supports the various scheduling activities and enforces business rules that are found in a dynamic business environment. However, the system 100 does not confine or restrain the order in which those activities are performed.

Analysts and facility representatives specify demand for commodities at production or distribution facilities while schedulers specify plans to build or draw from the existing inventory. Commodities are acquired by traders or purchasing agents while the position is continually monitored by facility and or commodity. Schedulers perform an iterative cycle of planning, optimizing, generating, nominating and tracking the movements that transport the commodities from the point of purchase to the point of manufacturing or sale. The scheduling business process of the present invention is preferably iterative because carriers may require revisions to the nominations after having received and/or processed the original nominations that arrive from numerous shippers. In addition, the process is iterative because schedulers must handle unplanned, real-life situations such as delays and loss of materials occurring during transport and or the temporary or complete loss of a means of transport resulting from some catastrophic event. It should be noted that one of the features of the present invention is that it reduces the need for interactive supply chain operations and activities. Moreover, the structure of the objects of the present invention supports forecasting, planning, execution, and accuracy of supply chain information in comparison to prior art systems.

Referring to FIG. 7, input from the scheduler 322 and/or the facility representative 704 is fed into the accounting aspect 128 (see FIG. 1) as illustrated in FIG. 7. The accounting aspect 128 contains various functions and modules, specifically, the enter/modify demand function 710, the enter/modify planned inventory build or draw function 712, the enter/modify consumption function 714, the enter/modify production function 716, the enter/modify inventory buy or sell function 718, the link inventory buy or sell to contract function 720, the confirm inventory buy or sell function 722, the enter/modify net outs function 724, the enter/modify movement function 726, the generate transport contract function 728, the import batch schedules 730, the monitor FIFO function 732, the monitor position function 252 (see FIG. 2), and the monitor inventory function 736. After processing by the accounting aspect (typically by application of the input data to one or more of the above-mentioned functions) a check is made in step 740 to determine if a nomination is ready to be generated. If the nomination is not ready for generation, then execution loops back to the entry into the accounting aspect 128 as illustrated in FIG. 7. Otherwise (i.e., the result of step 740 was positive), execution moves to step 742 wherein the nomination is generated. Thereafter, a check is made in step 744 to determine if the nomination is ready. If not, execution moves back to the entry into the accounting aspect 128 as illustrated in FIG. 7. Otherwise (i.e., the result of step 744 was positive), execution moves to step 746, wherein the nomination is distributed to the interested parties/processes. Next, in step 748, a check is made to determine whether a carrier revised the nomination. If so, (i.e., the result of step 748 is positive), then the revised nomination is received by the carrier in step 750 and execution loops back to the input of the accounting aspect 128 for further processing as illustrated in FIG. 7. If the result of step 748 is negative (i.e., there were not changes made to the nomination, then the nomination is executed in step 749.

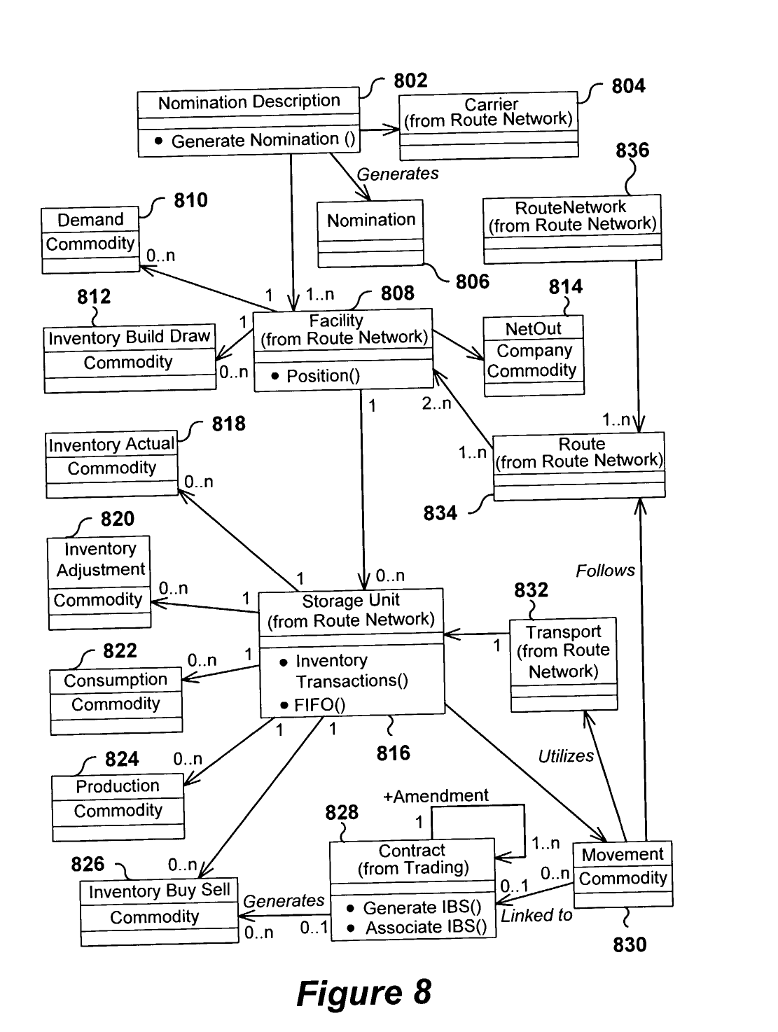

FIG. 8 illustrates the scheduling model of the present invention and its relationship to other functions. Facilities, storage units and routes that come from the route network system are central to the scheduling process. Each of the scheduling activities is applied to, or affects the state of, the facility or the storage unit.

The scheduling model 800 is illustrated in FIG. 8. The nomination description 802 has relationships with the carrier object 418 of the route network aspect 130 (see FIGS. 4 and 1, respectively), and with the nomination object 806 which is generated by the nomination description object 802 via the generate nomination method. The nomination description object 802 has relationships with one or more facility objects 408 (also from the route network aspect 130, see FIGS. 1 and 4). Each facility object 408 has relationships with zero or more demand objects 328 and with zero or more inventory build/draw objects 330 (see FIG. 3). The facility object 408 also has a relationship with the net out object 814. As was illustrated in FIG. 4, each facility object 408 has a relationship with zero or more storage unit objects 410. Each storage unit object 410 preferably has a relationship with zero or more inventory actual objects 818, zero or more inventory adjustment objects 820, zero or more consumption objects 822, zero or more production objects 824, zero or more inventory buy/sell objects 320 (see FIG. 3), and movement object 830. The movement object 830 has relationships with the route object 424 (see FIG. 4). Zero or more movement objects 830 are linked to zero or more contract objects 314 as illustrated in FIG. 8. The movement object 830 also has a utilization relationship with the transport object 414 (see FIG. 4). Each transport object 414 has a relationship with the storage unit object 410 as illustrated in FIG. 8. As was illustrated in FIG. 3, zero or one contract objects 314 generate zero or more inventory buy/sell objects 320. As was illustrated in FIG. 4, the route network object 426 has a relationship with one or more route objects 424. In the preferred embodiment of the present invention, various properties are accessible to some or all of the objects of the present invention. For example, the commodity property (illustrated in the various objects of FIG. 8) is accessible at the facility level, or at the location level (which is an aggregation of commodities at all facilities for that location).

Demand

At the facility level, traders, analysts, facility representatives and purchasing/sales personnel forecast the need for commodities for a specific time-period by creating records of demand. Demand does not impact inventory, rather it is a means of specifying what commodities are expected to be provided at a facility. Demand is an essential element of the position calculation (REFER). The demand projection is usually derived from past trends, surveys and or complex business simulations. The system 100 of the present invention provides the user with different views of the demand data including, but not limited to: listing the demand for all or a group of commodities at a single facility; and/or, listing the demand for a single commodity at all facilities throughout the route network. Additionally, the system automatically captures the state of the demand plan at different stages in the planning cycle enabling users to see how demand changed with time which can be particularly helpful during post-mortem studies.

Inventory Build or Draw

Demand can be met by purchasing, manufacturing, or drawing from existing inventory. Schedulers must manage the inventory throughout the route network, and they plan inventory changes at the facility level by creating inventory build or draw records. The inventory build or draw records specify targeted increases or decreases in inventory by commodity and by facility for a specific time-period. As with demand, inventory build or draw records do not impact inventory; they do not represent actual receipts or deliveries, rather they allow schedulers to define objectives and then to check whether or not they have met those objectives. The inventory build or draw records are a critical element of the position calculation (REFER).

Inventory Buy or Sell

In the case of a physical deal, traders arrange for the exchange of some quantity of one or more commodities. The contract object (refer) from the trading system records the details of the agreement and generates the legal document. However, the contract object does not directly record the details of what is actually traded nor does it in anyway directly impact inventory. Instead, the scheduling system provides inventory buy or sell objects to model and record the change of ownership of some quantity of a commodity with another party.

Inventory buy or sell objects represent scheduled and actual receipts or deliveries of a commodity and therefore do impact inventory. Inventory buy or sell objects can be linked with a contract so that the actual receipts and deliveries can be compared with the details specified by the contract. When a contract is released to scheduling, the scheduling system automatically generates inventory buy or sell records based on the information contained in the contract and links them to the contract. The scheduler will then update the inventory buy or sell record as details of the exchange become available.

Sometimes the quantity to be exchanged is not known at the time the agreement is established. In some instances, the exact quantity is it known for long after the contract has been established. For example, two parties may agree to exchange the crude oil produced by a lease. It is impossible to know in advance exactly how much crude oil will be produced each month. In these cases, historical data may provide a good estimate for future deliveries. Therefore the inventory buy/sell (“IBS”) mechanism of the present invention provides a method to forecast future quantities by averaging quantities from the three previous IBS's. The scheduler may choose to estimate the scheduled volume based on the forecast volume.

As the date of exchange approaches, scheduled quantities and dates are typically determined by agreement of the schedulers from both parties that are listed on the contract object. This process is called confirming the inventory buy or sell in the scheduling system. Schedulers can easily query for confirmed or unconfirmed inventory buy or sell records. In addition, if an inventory buy or sell record has been confirmed, but changes are made to the record after being confirmed, the system will automatically mark the record as not being confirmed.

Occasionally, traders inform schedulers of contracts they are working on but have not yet released to scheduling. This situation arises when most of the details of the deal are known or expected but the contract can't be created and released because some aspects of the deal are still being negotiated. The scheduler may want to begin the scheduling process prior to finalization of the deal. In those cases, the scheduling system allows schedulers to create inventory buy or sell records manually without associating it with a contract. Later, when the contract is completed and released to scheduling, the scheduler can manually link the inventory buy or sell record with the contract. The system facilitates the manual linking process by only listing those contracts which match the details of the IBS. Once an IBS is linked with a contract, the system will ensure that it is updated when changes are made to the contract.

At any given time, it is possible for one or more of the IBS's of a contract to be missing. This situation can arise because 1) schedulers can manually delete IBS's and 2) the scheduling system only generates IBS's one year in the future. In the latter case, additional IBS's must be generated as time passes if the contract is valid for more than one year. The scheduling system ensures that missing IBS's will be automatically generated any time a user queries for IBS's or performs an operation which depends on IBS's such as calculating inventory or generating nominations.

IBS's are an integral part of the commodity position calculation(refer) in that they are one of the means by which the demand for a commodity can be met. However, the point of possession generally differs from the point of demand and the commodity must be transported from one point to another. It is critical then to account for the time required to transport the commodity to the point for which the demand was entered when determining which IBS's should be included in the position calculation for any given planning period. The IBS object allows the schedulers to specify arrival times by specifying the run month.

Although, a contract may only list a single commodity and quantity to be bought or sold, the seller may meet the obligation by making several smaller deliveries until the total quantity has been delivered. Initially, the quantity and timing of the partial deliveries may not be known. The scheduler will want to enter the total quantity in the system to get an accurate forecast of the inventory. Then, when partial deliveries are scheduled, they too will be entered in the system. The scheduler must however, ensure that the total IBS volume remain unchanged as the partial deliveries are made. In addition, the scheduler will want to be able to easily determine the quantity remaining to be delivered. The IBS object will automatically manage this situation when the scheduler marks a single IBS line item to be adjusted in a manner consistent with maintaining a constant total IBS quantity while other line items are added, deleted or modified.

Movement

The scheduling system provides the movement object for the planning, tracking and optimizing of the redistribution of inventory across the route network. Movement of a commodity follows a pre-defined route in the route network from one storage unit to another storage unit at the same or a different facility and the commodity may pass through one or more intermediate storage units before arriving at the final destination.

The movement is executed by a carrier using some means of transport(refer)such as but not limited to a pipeline, barge, vessel, rail car, truck or airplane.

When viewing inventory history at a single facility or storage unit and examining a single receipt or delivery associated with a movement, the movement object enables the system to list the origin, destination or any intermediate facility associated with that receipt or delivery and the corresponding times of arrival and departure.

The movement object supports methods for merging one movement with another or for splitting a single movement into multiple movements. This can be particularly useful when separate schedulers are responsible moving commodities across different sections of the route network.

The scheduler must know how long it takes to move a commodity from one facility to another using the various means of transport when defining movements. Often, the transit-time is constant within a level of tolerance which is acceptable to the scheduler during the planning phase. Therefore, when a movement is created or modified, the transit-time for each leg of the movement is calculated using the specified departure and arrival times and then saved as information with the route object. The next time a movement is created or modified, the arrival times will be automatically defaulted based on the departure time and the previously calculated transit time.

Many schedulers must deal with large numbers of movements in any given planning cycle. Entering these movements into a system can be a time consuming task. The scheduling system provides the capability to quickly and easily specify and generate a large number of movements in an automated fashion. For example, the movement object supports a method of replication which produces a series of similar movements occurring in specified multiples at each instance of an equally spaced time intervals spanning an initial and final time as specified by the scheduler.

When a commodity is moved from one facility to another, the quantity being moved is typically measured at both ends of the movement as well as at any facilities the commodity may pass through along the way. Frequently, the measurements indicate the quantity originally shipped is not the same as the quantity which ultimately arrives at the final destination. This can be attributed to gains or losses that may occur during the movement or to inaccuracies in the measurement process.

The scheduling system calculates and maintains historical records of gains and losses that occur during movements. The gains and losses must be accounted for when figuring in-transit inventory. For example, if a vessel is completely unloaded, its inventory should then be zero. If measurements show that a larger quantity was loaded than unloaded, the difference is assumed to be a loss and will be subtracted from the vessel's inventory. Historical data can show that some transports typically have higher loss ratios than others. Action can then be taken to reduce the losses by consulting with the carrier or switching to another carrier.

The Scheduler may negotiate a transportation agreement with a transportation supplier and enter the resultant contract into the system. The scheduler may then link the associated movement with the contract for cross-referencing.

Inventory Adjustment

At times, the scheduler may find that the inventory calculated by the system does not agree with measured values or with statements obtained from other responsible parties. This situation may arise because one or more transactions were not properly entered in the system or because the values entered in the system were inaccurate. The scheduler may correct the discrepancy by either specifying an inventory actual (refer) or an inventory adjustment.

An inventory adjustment is a fictitious receipt or delivery of a commodity at a storage unit. The scheduler can size the inventory adjustment to give the desired or known inventory. The inventory adjustment object includes a place for the scheduler to add comments which fully document what is known about the discrepancy being corrected and on what the corrected values are based on.

Consumption and Production

A point of manufacturing converts one or more goods or commodities into a different product for sale or use elsewhere by applying one or more processes such as assembling, blending, combining, shaping or some other method. After successful manufacture of a good or commodity, the inventory of the produced good or commodity must be increased by the amount produced, and the inventory of the goods or commodities used as input to the manufacturing process must be decreased by the amounts used.

The scheduling system facilitates the entry and tracking of this information via the consumption and production objects where the consumption object is used to specify the inputs to the manufacturing process and the production object is used to specify the output or produced product.

The scheduling system is further capable of maintaining, recording and correlating, with other integrated scheduling subsystems, estimated and actual production figures for a commodity within a particular manufacturing facility. The system is able to generate per-day consumption and production estimates, given a lump sum amount, by applying algorithms to produce series of fixed-rate items that reflect the time span and rate of production, as specified by the scheduler. The rate of production for a given commodity can be estimated and/or actualized per day, per storage unit, thus allowing for a great deal of granularity in the resulting information set.

Net Out

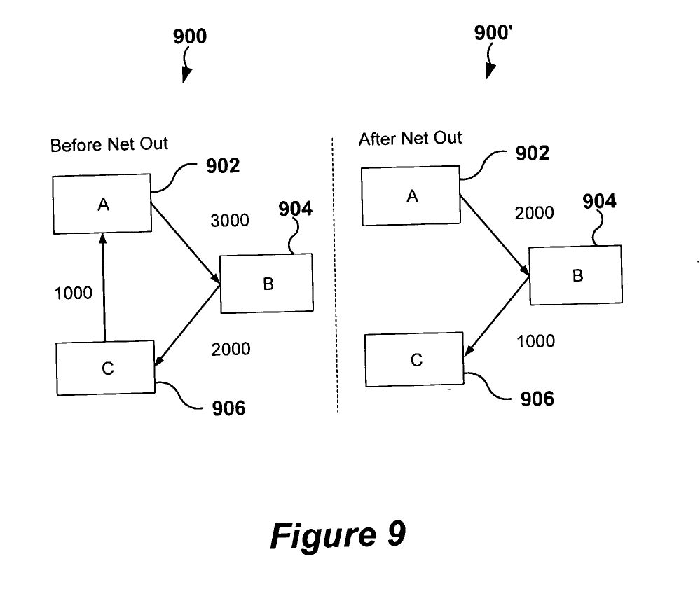

A net out is the process of minimizing unnecessary commodity movements by optimizing the number of physical displacements of commodities that must take place in order to satisfy a set of trade agreements between various trading partners. This exercise results in net savings for each of the trading partners, since the cost of making redundant deliveries and/or accepting receipts is minimized or eliminated altogether. FIG. 9 shows an example of how a set of agreements may be netted out.

Referring to FIG. 9, the before net out configuration 900 is contrasted with the after net out configuration 900′. Company A 902 is under contract to deliver 3000 units of some commodity to company B 904. Company B must deliver 2000 units to company C 906 and finally company C must deliver 1000 units to company A 902. One possible net out arrangement 900′ would then be for company A 902 to deliver 2000 units to company B 904, company B 904 to deliver 1000 units to company C 906 and company C 906 makes no deliveries.

Since each company only has access to its own trades, individual companies can only identify a small subset of the possible net out arrangements. However, in some industries, independent organizations are established and granted access to trade information for each of the participating companies with the intent of identifying and establishing net out arrangements. The scheduling system provides the net out object whose purpose is to capture these arrangements and to ensure that the proper quantities are nominated (refer) to the carriers.

Nomination

A nomination is a report sent by a shipper to a carrier for the purpose of proposing a set of movements for a planning cycle. The carrier, after receiving the nominations from all shippers, develops and optimizes a schedule for carrying out all the movements for each shipper. Many times, the carrier will be unable to meet the requests of all the shippers and hence will send a revised schedule back to the shippers. The whole process is then repeated until both carriers and shippers have agreed upon a set of movements.

The scheduling system provides methods which collect the pertinent data, process it and generate the nomination in a format acceptable to the carrier. The system provides the nomination description object which defines the criteria for determining what information will be included in the nomination, the processing options, the format of the report and the recipient.

The Nomination object is used for persisting actual nomination reports. The nomination object supports revision tracking which is designed to allow for quick identification of modified report items while automatically managing report versions and associated maintenance. The customization of reports to specific recipients allows the data to be presented in the form most useful to that particular recipient.

Position Calculation

The facility object provides a method for calculating position. The information included in the position calculation may have come from several different sources including: production, sales, scheduling, trading and analysts. Typically, production sales or analysts enter the demand for a commodity. The demand is the forecasted or planned requirements for a given commodity for a specified time period.

Demand is entered by facility and by commodity but can be viewed in many different ways such as the total demand for a commodity at all facilities or the total demand of all commodities at a single facility.

Schedulers enter planned inventory build or draws when they plan to increase or decrease the inventory of a commodity at a specific facility. Traders or analysts enter trading Assumptions. An assumption is a plan to exchange one commodity for another rather than to purchase or sale that commodity outright. Assumptions are an essential element of the position calculation.

The position is determined for a commodity and time period by summing all the inventory buy or sell entries that have been generated from the contracts or that were manually entered by schedulers, subtracting all demands and planned inventory builds, adding all planned inventory draws and incorporating all trading assumptions. The position can be calculated by commodity or by commodity and facility.

Inventory Calculation

An important part of the scheduling process is managing the inventory. Schedulers must be able to determine how much of a given commodity is currently in inventory and where it is located. They must also be able to forecast how the inventory will look in the future and they must ensure that tank levels stay between minimum and maximum levels at all times.

The scheduling system allows the scheduler to display all receipts and deliveries coming into, or going out of a single storage unit or an entire facility along with the running inventory for a specified time period. The inventory can be for a single commodity, a subset of commodities or all commodities. Inventory is tracked and computed to a precision of one second intervals. All transactions that affect inventory have a start and end time. If the inventory is requested for a time that falls between a transaction's start and end time, only that portion up to the requested time is included in the calculation.

The following steps are carried out during the calculation of inventory: 1) the system finds the most recent actual inventory that occurs prior to the requested time. 2) The system finds all receipts and deliveries that occur after the most recent actual up to and including requested time. 3) The receipts and deliveries are then accumulated along with the inventory actual.

Additionally, each receipt or delivery may have more than one volume associated with it, i.e., a scheduled volume, adjusted scheduled volume and/or actual volume. This allows schedulers to keep track of what was planned versus what actually happened. The receipt or delivery volume used in the inventory calculation is determined as follows: use the actual volume if it exists, else the adjusted volume if it exists, else use the scheduled volume.

At any given instance in time, inventory will be in one of two places, in storage or in-transit. The scheduling system can account for the total inventory, not just the inventory in storage. When a movement is created in the present invention, additional receipts and deliveries are automatically created and logged against a storage unit set up to represent the transport used for the movement. The receipts and deliveries assigned to the transport storage unit mirror those of the movement. Therefore, when a commodity is moved from one location to another 1) it is removed from the movement's origin storage unit 2) placed in the transport storage unit 3) resides in the transport storage unit for the duration of the movement 4) removed from the transport storage unit 5) placed in the movement's destination storage unit.

FIFO Calculation

For reports, such as those required by a Foreign Trade Zone, the scheduler must be able to specify the final destinations of the entire contents of a vessel received at a load port. When the vessel is unloaded, the commodity is placed in some type of storage facility. The contents of the vessel may then be split into multiple batches and sent to more than one final destination. Typically, many movements will be received into, and delivered out of the storage unit over a period of time. If additional movements are received into the storage unit before the preceding movement is completely delivered out, it may no longer be possible to specifically identify which delivery goes with which receipt. Therefore, an assumption must be introduced in order to make the problem deterministic. Two such assumption are FIFO (first in/first out) and LIFO (last in/first out). The present invention provides an option to enable the FIFO or LIFO calculation on any storage unit in the system. This allows schedulers to automatically generate reports such as those required by operations coordinators, accountants, or government reporting. Other types of queuing schemes can be used with the present invention when those alternate queues are more useful for modeling the desired characteristic of the supply chain.

4. Client Services

Overview

Client services provide user-level functionality and programmatic APIs (application programming interfaces) for machines hosting the end-user application. These services form the base infrastructure on which application user interfaces are built. There is a high degree of integration which can be achieved between client services architectures and other software layers that utilize them. The following sub-components of the client services provide such integration.

External Data Inter-Exchange

The external data inter-exchange sub-system (“EDE”) 108 is designed to allow seamless integration between the system 100 and external systems. At the core of the EDE design is the utilization of platform-independent protocols and generic logic. The platform-independent features allow the system 100 to communicate within heterogeneous systems, whereas the generic design and implementation of the present invention allow it to handle a variety of tasks without requiring significant modification.

The main goals of the EDE sub-system 108 are:

Tight integration within the supply-chain management series of vendor and suppliers;

Plug-in modularity for enabling JIT (Just-in-Time) functionality; and

Business-to-business (“B2B”) and enterprise application integration (“EAI”) capabilities. EAI refers to uniformly constructed data and processes that can be used in interfaces between disparate organizations. Generally, such data consists of brokering data and data bus capabilities for inter-application communication across potentially unlike platforms.

As described above, the EDE, subsystem 108 enables the present invention to integrate and share data with external systems. This section describes in more detail the components that make up EDE and the way in which the present invention achieves these goals.

Functional Layers

EDE is comprised of software layers, each dedicated to performing specific functions on behalf of the larger system. There are specific areas dedicated to connectivity, business logic, and translation from native to common data formats, object instantiation, and persistence.

Connectivity

In order for this system to establish connections to other systems, it must support a gateway for linking to other systems in a generic way. To ensure that multiple platforms are supported, the HTTP protocol is used as the communication medium between systems. Likewise, to guarantee that the data format used atop the communication medium is understood in different environments, XML documents and schemas are used.

The combination of the HTTP protocol and the text-based XML document/schema encoding style provides the flexibility needed to satisfy the requirements of platform independence. Furthermore, the utilization of the HTTP protocol and its disconnected properties make it ideal for this type of environment, especially during times of high network traffic.

Business Logic

This system is capable of generating a specialized set of business components for handling external invocations. These components are hybrid objects, which are able to translate from the common format used to communicate with external systems, to internal data structures.

These objects receive the external data packets and ultimately execute the logic functions intended by the external caller(s). Once executing within this system, these objects have the full capabilities of any native system component, sharing the ability to read and write data to memory or disk, as in cases where database tables are modified or internal memory structures are read and written during program execution.

In this way, these specialized, hybrid components are exposed to other systems presenting a standard interface. This capability allows this system to be truly open in its ability to send and receive messages to and from a variety of external systems.

Translation Layer

One of the most critical pieces required for the implementation of open systems is the ability to perform conversions between external data formats and the native format of the system. This functionality must be accurate and above all, high-performance, in order to sustain high call volumes and still give the system's users the responsiveness they need. The implementation of this translation layer is optimized to run on its native platform and makes extensive use of in-memory processing.

This implementation of the translation layer is highly configurable, making it ideal for handling the myriad different data exchanges that could take place within and without a supply-chain management software package.

Persistence

This systems ability to communicate with business partners through software is not limited to logic processing. The implementation of the system is capable of receiving data batches for direct storage within the internal database. This capability permits external data feeds to be stored and used internally for line-of-business support and decision-making. In fact, the EDE implementation serves a crucial role in the integration of supplier data for the purpose of scheduling and trading decisions.

Intelligent/Integrated Controls

This is the set of core user-interface controls (such as list-boxes and combo-boxes) that make up the functional aspects of the user interface. These controls are tightly integrated with the rest of the application, to provide the user with the essential bits of information at the appropriate times. These controls are highly configurable and flexible, allowing software developers assigned to creating user applications to customize functionality to user requirements, in an uncompromising fashion.

Intelligent/Integrated Forms

All of the aforementioned controls need a window, or form, on which to be placed. There are many ways to put controls on forms, from the very basic approaches provided by Microsoft's Visual Basic, to custom infrastructures such the one described in this document. The present invention's approach to user-interface development is geared toward providing value-added features such as custom data incorporation, integration and discovery of constituent controls at run-time, and even-driven features which would be extremely difficult and time-consuming to perform under other environments.

Data Cache

The Data Cache feature of the present invention ensures that client-side data manipulation is performed in the most efficient way possible. Where most systems rely on the flow of relational data back and forth, from the source of the data to the user interface, the present invention employs an intricate system of in-memory data caching. This scheme greatly improves the performance of the application, by reducing the number of round-trips required between the actual source of the data and the place where the data is manipulated by the users, which are usually two different places in the network.

Preferences

The storage and display of user preferences is not a new concept in software application development, but it is a tedious, and frequently performed, task Most application development environments provide little if no intrinsic support for managing user preferences. the present invention's support for user preferences is built from the ground up, with features that encompass not only the basic look-and-feel of the application, but also the layout and behavior of controls displayed on the screen.

Communication Interfaces

In order to support appropriately the business requirements of a full-fledged, distributed, supply-chain management application such as the present invention, communication between the software components that perform the work needs to be efficient, robust, reliable, and flexible. In this environment, software objects of the present invention may be distributed among several computers. These computers need not be close in proximity, so network traffic must be considered as a factor in the intercommunication between distributed objects.

The distributed object protocol used by the present invention application infrastructure is a customized implementation, which makes use of low-level functions provided by the underlying OS (operating system) to ensure that the most efficient use of network resources is exercised during high usage loads and time-consuming calls between components. Without this degree of customization, application performance would degrade considerably during times of high network latency and traffic.

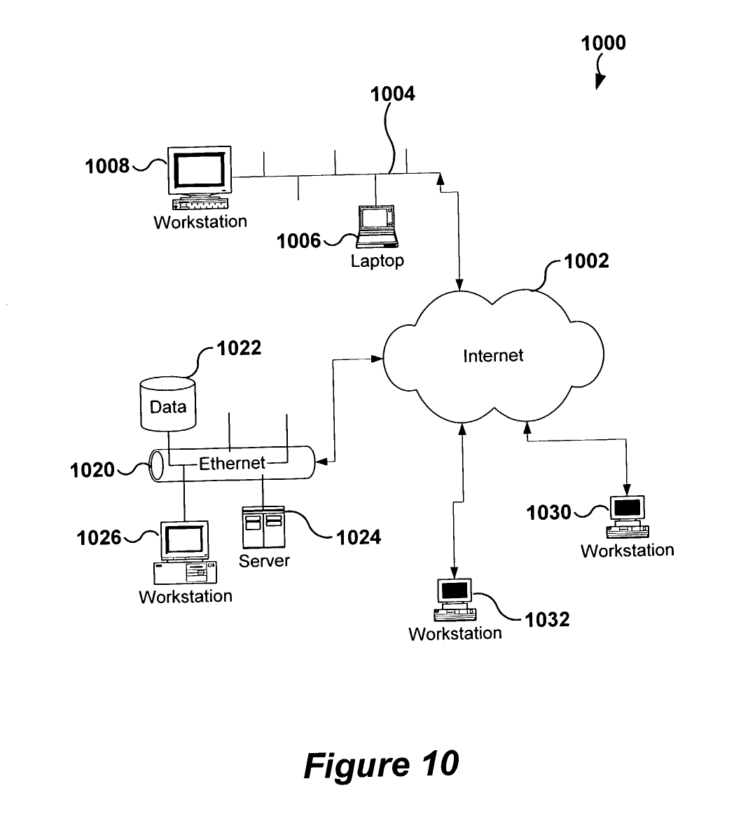

The present invention may be implemented on a computer network, such as the one illustrated in FIG. 10. The persisted data related to the present invention may be stored on the database 1022 in the form of an object, object-relational, relational database, or the like. The database 1022 would preferably be accessible via a network, such as Ethernet 1020, with any pre-processing or post-processing performed on server 1024. This local are network can be monitored via workstation 1026. The database 1022 and processing capability (via server 1024) is preferably made accessible on a wide area network, such as the Internet 1002. Individual client devices 1030 and 1032, and their uses (such as schedulers and traders) would then be able to access the functionality of the present invention. The operations of external organizations can be integrated with the present invention. For example the local area network 1004, which includes interconnected devices such as workstation 1008, laptop 1006, milling machine 1010, and storage container 1012 could also be connected to the wide area network 1002 and thus to the present invention that is implemented on, for example, local area network 1020. The production results of the machine 1010 could be used as inputs to the various objects of the present invention, which could store the results as properties or, based upon the circumstances, implement a method to take some proscribed action. Similarly, trades and contracts conducted via the system 100 of the present invention may cause one or more objects of the present invention (operating on the server 1024) to issue signals to, for example, storage container 1012 to disgorge a specified amount of a commodity. Similarly, a scheduler operating on workstation 1032 could, via the generation and implementation of a contract, cause the business logic of the newly formed contract object (that is instantiated on, for example, server 1024) to send a signal to transportation unit 1050 via telecommunications link 1052 to retrieve the commodity from the third party's storage facility 1012. It should be clear that the present invention can be used by human users, and by autonomous and semi-autonomous processes operating, for example, on server 1024, to receive data from various sources, process the information, and report and/or cause other users and/or machines to perform various functions within a supply chain.

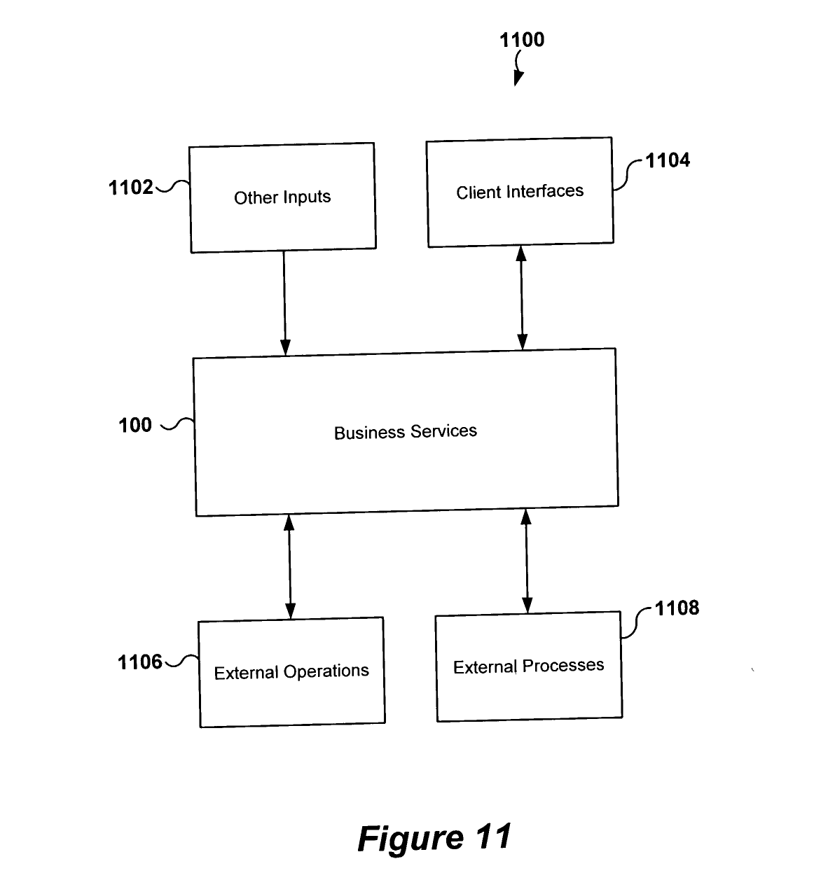

The present invention, as described above, may be made part of a larger system, as illustrated in FIG. 11. The system 100 of the present invention may receive inputs from client interfaces 1104, or other inputs 1102. Similarly, information to or from external operations 1106, or external processes 1108, can extend the influence of the present invention beyond the confines of a single organization. For example, the present invention may be hosted as an application service provider on a network of a first party. Subscribers to the application service provider could then generate and utilize the various objects of the present invention to perform specific tasks. Similarly, the operators and/or machines of third parties may be manipulated by the present invention as a result of demand, or supply. For example, client interfaces 1104 may be used to send a request which is processed by the system 100 of the present invention by the client services 102, the business services 120, and/or the technical services 140. Depending upon the type of request information may be obtained from other inputs 1102 and/or external processes 1108. Signals may then be generated to cause one or more external operations 1106 to perform some action that is specified by the system 100 of the present invention as a result of the contract generated, and the methods of the objects so implemented.

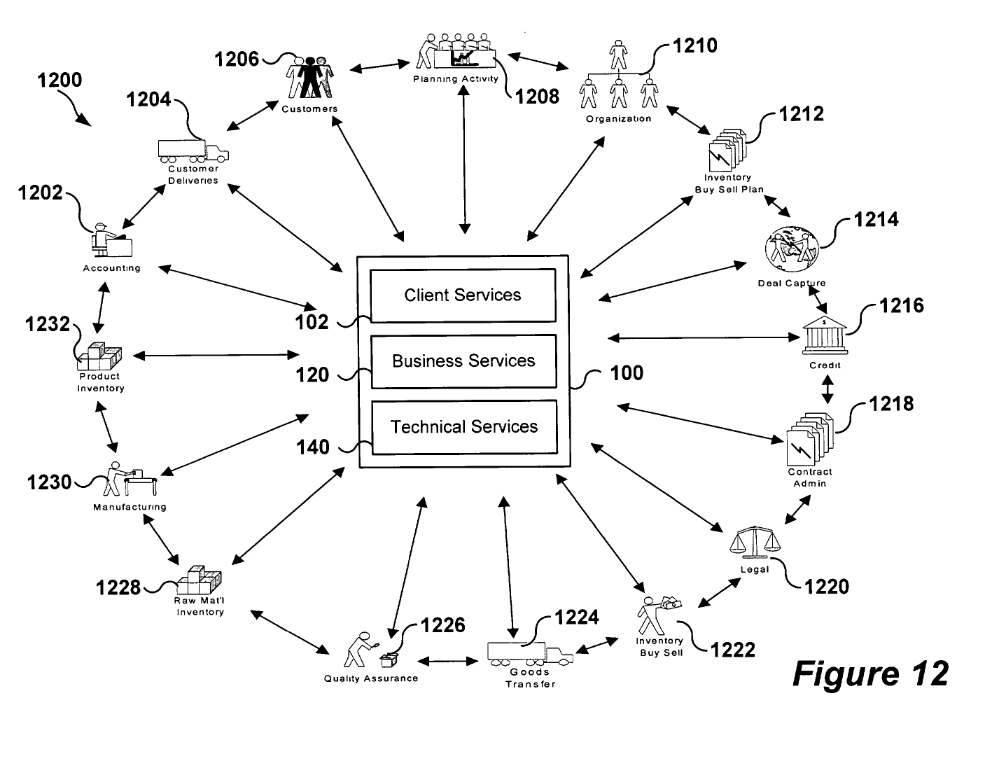

FIG. 12 illustrates the potential of the present invention to be utilized in all aspects of a supply chain. Referring to FIG. 12, the system 100 of the present invention is the central hub of communications between various parties and activities. In the preferred embodiment of the present invention, each of the parties or activities may send/receive information from the system 100 of the present invention. Moreover, the various parties and processes associated with the supply chain can communicate with each other, but the information that they convey can be enhanced or monitored or controlled by the present invention. The present invention is contemplated to interacting with accounting 1202, customer deliveries 1204, customers 1206, planning activities 1208, organizations 1210, inventory buy/sell plans 1212, deal capture activities 1214, credit 1216, contract administration activities 1218, legal activities 1220, inventory buy/sell activities 1222, goods transfers 1224, quality assurance 1226, raw materials inventories 1228, manufacturing activities 1230, and product inventories 1232.

As illustrated in FIG. 12, the present invention is a supply chain management application that provides significant value across a user's entire supply chain, from raw materials to final customers. The present invention provides a standardized, complete and relatively easily customizable data, information and knowledge exchange and supply chain operation application for possible use by all supply chain participants, both within and outside of a given workgroup or organization.

The present invention can be used to satisfy supply chain concerns, such as:

How many packages do I need to purchase, sell, exchange, produce, process or store?

How many do I currently have?

What are the contents?

Where are they?

When will they arrive?

What is the cost basis?

What is the current market value?

How much do I need to hedge?

In the preferred embodiment, the present invention utilizes reusable components that seamlessly communicate with other components, thereby enabling supply efficiencies, optimization and new business models not previously possible.

FIG. 12 represents the key business functions of a typical manufacturing or raw material processing supply chain. A feature of the present invention is its unique ability to handle, be supportive of, or be easily modified to accommodate efficiently all real-life supply chain activities. Prior art systems typically required a specific starting point, such as a contract, a feedstock selection process, or other supply chain activity. In contrast, the present invention supports the iterative, often ‘out of the blue’, simultaneous, parallel and sequential situations that are typical of supply chain operations. Hence, the use of a hub and spoke depiction of supply chain operations that is illustrated in FIG. 12. At any point in time or order, the supply chain participants and the data exchange functions can access or contribute data and information to the supply chain operations and management process. Further, the present invention is designed to accommodate the required back and forth and many-to-many communications or exchanges between supply chain participants and processes. The present invention centralizes the multiplexed communications information flow and simplifies complex communications in an effective architecture.

The discussion below is simply meant to be illustrative of the present invention's functionality in one supply chain example using one set of activity assumptions. However, the example discussed below is not only way the system operates or the only business model it supports. The present invention is useful for many other supply chains and circumstances.

In this first example, supply chain activity discussion starts with the planning activity 1208 (see FIG. 12). Effective supply chain planning requires knowledge of current and planned activities, physical and financial positions. The present invention supports planning activity by providing inventory positions, linkages to historical and current market and internal transfer prices. The present invention is provided with physical and financial commodity position functionality that provides historical, present and future commodity or goods supply and demand requirements or targets, movements, prices, outstanding contracts, quality information, customer, supplier, location and routing and other information. The necessary information may be contained in a database associated with the present invention, or in other databases that may be accessed during the planning process. Because the present invention is preferably web-based, participants need not be in the same location. Instead, the users can be anywhere that is connectable to the wide area network, such as the Internet. The present invention preferably includes security, messaging, synchronization and other features under the rubric of the technical services 140, external data inter-exchange, data cache, integrated forms and other features under the rubric of the client services 102 that are needed to support the business services 120 including, for example, the planning activity 1208. The present invention provides a standard and consistent way of enabling information exchange across all supply chain functions by exploiting standards-based communication protocols. Consequently, the present invention obviates specialized human and electronic interfaces that in the prior art were needed to accomplish information access and flow, and to fill in the inherent gaps between their supply chain functions.

The present invention provides an easily configurable and secure approval authority, messaging, and other organizational support functionality. The present invention supports on-demand review of and participation in planning activities 1208 by supply chain management and other personnel 1210. Management and other organizational performance 1210 is supported and enhanced as result of the information accessible via the present invention. For example, case management 1210 is aware of crude oil purchases and the LPG sales requirements. The results of planning activity 1208 can proceed with the appropriate Management 1210 approvals that are established and handled by the present invention's security components that are embedded within the technical services layer 140.

The need for raw material acquisition and in-process and finished product sales is accommodated by the inventory buy/sell plan 1212 that is one of the outputs of the planning activity 1208. This buy, sell, exchange of goods or financial instruments, i.e., futures contracts, swaps, others or related transaction activity will, for purposes of this description, be referred to as Trading to distinguish it from other supply chain activities. The movement timing, routing and location aspects of the physical commodity that is associated with the Trading activity will be referred to as Scheduling, which is part of the scheduling aspect 126 (see FIGS. 1 and 8). In the present example, the respective Traders and Schedulers 126 interact via the present invention with the planning personnel 1208 and other internal and external supply chain participants to insure the plan for acquiring the 1,000,000 bbls of crude and selling the 2,000,000 bbls of LPG following its production. Everyone is authorized via the present invention security mechanism 154 to have easy access to the LPG supply and Crude Oil demand situation. Further, the present invention provides effective access to any of the available internal and externally generated market pricing, transportation costs and other market intelligence for crude oil and LPG. The present invention also allows determining and monitoring supply chain inventories and other information that relates to the 1,000,000 bbl crude acquisition and 2,000,000 bbl LPG sale. The present invention also allows supply chain participants to handle, profitably and efficiently, the example supply-driven inventory sale and demand-driven inventory buy requirements (see FIGS. 8 and 12).

The present invention supports development of a deal with a counterparty or third party for required commodities or goods. Stored and ad hoc pricing formulas, access to on-line and historical price information, commodity quality specifications and other information necessary for completing an actual or tentative deal is handled by the present invention's deal capture 1214 functionality. This functionality supports capture all of the information that, at the moment a deal is consummated, may only be available in the mind of the Trader and their counterparty. The present invention's deal capture 1214 handles spot, term, evergreen and exchange deals involving any defined commodity, location, time frame, units of measure, and other terms and conditions. The ability to capture deal information quickly and efficiently is important to all supply chain activities. The present invention can be configured to support all manner of transportation, deal types and commodities. In the present example, one Trader uses the present invention to decide to buy 500,000 bbls of physical crude using a complex pricing formula out of the present invention's formula library and 500,000 bbls on a future contract all set for delivery to the appropriate physical or contractual delivery locations. The other Trader decides to sell equal amounts of LPG over the coming months at flat price to a combination of counterparties some capable of receiving deliveries by barge, truck or pipeline; others by just rail or truck. All of the important aspects of these deals are captured using the present invention's deal capture module 1214. The present invention's ability to allow capture of all important aspects of the crude oil and LPG deals supports all the other functions up and down the supply chain. See, e.g., step 206 of FIG. 2.

The present invention includes functionality to store and to present credit information and to enforce credit rules or limitations that involve other party financial credit worthiness. How these rules are defined, applied and enforced by the present invention's business services 120, client services 102 and technical services 140 functionality. The present invention's real time web-based architecture and security system 154 allows credit worthiness information to be updated as required by authorized credit personnel. The present invention's position management, pricing and other functionality provides credit operations 1216 with the necessary information to support their activity effectively. Credit worthiness is a function of quantity, price, outstanding physical and financial balances, etc. Deals that do not comply with preset rules (that are definable within the present invention) cannot be entered into the present invention. By the same token, the present invention can be configured to retain the prospective deal information should it be desirable to do so, and to pursue arrangements to meet a credit requirement. This functionality can likewise be applied to the accounting oversight 1202 of futures and options contract exposure restrictions and the need for financial management tool use to hedge or reduce risk exposure due to pricing changes. The present invention also supports cash flow management activities. In the current example, because of the large values associated with the LPG sale, these deals require immediate review of other party credit limits that have been pre-entered into the present invention by credit personnel 1216. Based on the respective other party credit worthiness, sale quantities and terms can be adjusted during the course of deal making in order to comply with credit limitations. The current credit status can be maintained as the deals progresses through delivery payment because the present invention contains or has access to all the necessary pricing, volume and other information to track outstanding financial position. The financial position of the crude futures contract in this example can also be monitored by the Traders in the event that a sale of the futures contract is warranted due to price changes or demand changes that would affect the desirability of exercising the futures contract. See, e.g., step 210 of FIG. 2.

Tentative Trader commodity IBS and scheduler transportation deal capture information is converted to contract documents using the present invention's contract administration (CA) module 1218. The other party contracts are also input into, and managed by, the present invention. The contracts administration module 1218 supports other non-deal activity, such as other party contact information; invoice handling, financial risk management, accounting 1202, legal 1220 and management 1210 review and approvals, records retention and management requirements. The present invention can disassociate contract administration from other supply chain activities to whatever extent is necessary to complete the contract administration 1218, legal 1220 and other administrative functions separately, but still be able to link to the commodity movement and position activity. In the current example, the purchase and sales contracts associated with this example are generated with the present invention's word processing, contact information, pricing, routing, modification, status tracking and other functionality. Requisite approvals for the crude purchase and LPG sales are obtained and documented on-line consistent with the present invention's embedded and enforced rules. See, e.g., step 234 of FIG. 2.

Once the Trader has an acceptable deal with any required approvals, an actual IBS (inventory buy or sell) transaction is entered in the present invention. The IBS module 1222 represents an executed plan for a purchase or sale that will impact the supply chain's inventory position. It is the IBS that triggers actual movement scheduling and adjusts supply chain positions in support of ongoing planning activities 1208. It is largely the commodity, volume, quantity, time aspects of the deal that must be managed as opposed the financial and administrative aspects often associated with a contract that necessarily proceed on a different but linked path. The IBS 1222 is an important aspect of the present invention. In many ways, the IBS 1222 is the virtual commodity that must be scheduled, moved and tracked through the supply chain, from the completed deal to the final product or the contract disposition. The characteristics of the IBS object 1222 provide unique connection capability between the planning activity 1208, the Trading contract administration 1218, scheduling 126 and accounting 1202 and is the functionality that links the purchased commodities whether they be physical and paper deals. The present invention provides the ability to determine physical or paper goods transfer 1224, delivery or position requirements and status against a given supply or demand requirement or contract. The IBS object 1222 also support financial risk management as it links deals with the other supply chain positions. In the subject example, an IBS will be created for the acquisition deal(s) involved 1,000,000 bbls of crude and the 2,000,000 bbls of sales deal(s) for the LPG. See, e.g., FIG. 7.

Once an IBS object 1222 is created, all aspects of delivery or receipt Scheduling 126 can be completed. Physical transfers are virtual commodity movements that are routed through the supply chain using predetermined or ad hoc routing. Current route creation is manual but automatic ruled-based routing is a logical extension of this functionality that can be implemented using the present invention. Commodity or goods movements, receipts or deliveries and their associated attributes are linked to the appropriate IBS object 1222, the mode of transportation, the carrier, the facility, the location, the storage unit and other movement related functionality. Purchased, sold or exchanged quantities remaining to be scheduled delivered or received are tracked against the IBS object 1222 and hence tied back to the Trading, Planning and other upstream activity. The present invention rules do not prohibit physical transfers without completed or dummy IBS objects 1222. The present invention is unique in its ability simulate and seamlessly integrate important real world aspects of physical transfers to the rest of supply chain functions. The integration provided by the present invention supports more efficient and effective supply chain operation and management as the latter is less dependent upon systems that include, for example, status indications of material movements or related requirements but depend on manual intervention to incorporate supply chain tool actualization of the transfer. Hence, movement routing and other desirable rules or knowledge cannot be automatically incorporated into the transfer activity. The present invention creates or supports creation of the applicable transportation provider nomination forms, adjusts current or projected route inventories, supports attachment of movement related costs, quality assurance reports by internal or external parties. The present invention also supports capture of electronic external data feeds that contain the before mentioned information as well a batch flow rate, e.g., meter ticket, bill of lading, or batch status, storage unit inventory or any other information. The present invention is designed to retain historical planned and actual information, e.g., actual inventory or commodity counts and override plan information using defined rules. The physical transfer functionality of the present invention remains unchanged even though the attributes of the movement may be different at different points along the supply chain. Inbound movements contribute increased supply or inventory downstream and do the opposite upstream. The physical transfer functionality of the present invention can be easily made to apply to a route of any length, quantity or time frame. Whether a movement is from around the world or around the workbench, the inherent behavior is the same. The present invention does not limit the physical transfer functionality by inclusion of other supply chain functions that are not a part of a physical transfer. By linkage or communication with the other functions, the appropriate information is transferred within the present invention. The physical transfer feature of the present invention is a virtual movement, not a contract, or schedule or inventory. In the subject example, the 500,000 bbl crude futures contract can be converted directly or by trade into an actual physical delivery. The resulting physical crude movement from the futures contract as well as the 500,000 bbls of crude purchased outright from another source will be planned and routed via the appropriate or agreed upon mode of transportation and schedule. The present invention allows generation of crude oil pipeline nomination forms that will enable transport of the 1,000,000 bbls of crude to its destinations. Nominations are proposed shipment times and volumes on a pipeline. Shipper nominations are accepted, modified or rejected by pipelines depending upon available capacity and other factors. Being able to transmit the nominations to the multiple pipeline operators and being able to track and react to the resulting nomination changes is important. See, e.g., the steps of FIG. 7. The crude oil will be routed along the applicable route from point of origin to the desired destination using the present invention's physical transfer and routing functionality. See, e.g., FIG. 4. Historical, current and future position and inventory impact of the crude movement will be captured or entered into the present invention as information is made available manually or electronically. Likewise the status of the outbound LPG will be tracked by the pipeline batch, truck, tank car and barge load. Batch ETA (estimated time of arrival) information is calculated based on identical previous transfers, manual inputs or constantly updated ETA based on electronic feeds from transportation systems, i.e., pipeline SCADA, tank car tracking, manufacturing or processing facility information systems. The present inventions physical transfer information will be used as feedback to planning activity 1208 and to upstream supply chain functions for comparison to plan as well as feedforward information for planning, adjustment and management of related downstream operations. If the crude is going to be early or late, different than expected quality or quantity or the LPG sales not as planned the present invention's unique functionality maximizes the opportunity for appropriate supply chain monitoring, analysis, response, reporting, etc better than existing systems. See, e.g., the steps and elements of FIG. 7.

Product quality, or quality assurance 1226 is monitored across the supply chain from the gathering of raw materials through manufacture to final delivery. Product quality 1226 can change during the supply chain process as a result of various factors, such as product commingling, processing, storage etc. The value of the product changes as a result of quality changes. Supply chain participants expect the price to reflect such value changes. The present invention enables the tracking of such activity seamlessly throughout the process. In this example, the movements of crude and LPG are monitored at tactical and strategic points to ensure the quality purchased is the quality received. See, e.g., FIG. 7.

Raw material 1228 and product inventory 1232 functionality, alluded to previously, provides synergistic benefits when coupled to the present invention's other functionality. The present invention integrates historical, real time and future inventory information with the other supply chain functions and is unique in its ability to seamlessly handle raw material, in process and product materials with effective and efficient linkage to manufacturing, physical movements, external data feeds of any frequency, contracts, pricing and other supply chain information. Seemless integration eliminates errors related to things falling in the cracks or difficult to use systems put in place to move information from one function to another or embed and enforce rules and organizational knowledge within the application and across the entire supply chain operation. The present invention provides the ability to enable seamless integration. IBS quantities 1222 are handled along with manufacturing facility production 1230 and consumption. The inventory functionality 1228, 1230, and 1232 includes UOM (unit of measure) conversion capability, the ability to handle LIFO and FIFO inventory calculations. The architecture of the present invention supports viewing of inventory and other information on a secure basis by web browsers by anyone given the appropriate system security clearance. Inventory positions can be easily combined or rolled up by commodity type, business unit, facility, geographic location or other attributes. In the current example, the 1,000,000 bbls of crude and 2,000,000 bbls of LPG are added to and subtracted as appropriate from supply chain locations and storage units on a future plan, real time and historical basis as information is made available to the present invention. Inventory information related to the crude purchase and LPG sales can be viewed or communicated to all supply chain participants for decision making, action within the present invention application and in the real world as appropriate in support of value creation. See, e.g., FIG. 7.

The present invention links operational and commercial supply chain activities. The architecture of the present invention can support the incorporation of process operations using the same object oriented techniques. The present invention's existing functionality allows supply chain support right to the point where raw materials disappear into process or manufacturing equipment. The features of the present invention support scheduling and commercial activities likewise from the moment products emerge from manufacturing or process equipment. The functionality of the present invention monitors in-process materials and accommodates the impact of manufacturing on supply chain activity. In the subject example, the LPG is one of the products from the crude oil processing. The present invention is not the tool used by the personnel to operate or control the facility to make the conversion from crude oil to LPG or forecast how much of the crude oil will be converted to LPG. However, the present invention does handle management of the resulting quantities and accepts required external data feed from manufacturing operations and forecasting models in order to support supply chain including manufacturing and process planning.

Because the present invention's functionality reflects reality, it easily accommodates accounting requirements 1202. The present invention can be used to do accounting, yet simultaneously handle operational data requirements independent of accounting constraints. The present invention's rich and complete supply chain functionality is highly configurable and is extremely supportive of invoicing, exchange statement generation, tax preparation, commodity derivative instrument tracking, performance benchmarking and measurements, P&L contribution reporting, auditing, complex deal tracking and other accounting functions. In the subject example, the present invention functionality allows accountants 1202 and others charged with monitoring and accounting for profits, losses, cash flows, taxes, government reporting and others details of the crude purchase and LPG sale to better perform their duties. In most cases, acquiring 1,000,000 bbls of crude and selling 2,000,000 bbls of LPG will involve numerous complex deals, pricing, reporting requirements, performance reviews and the like. In the example of FIG. 9, some of the 1,000,000 bbl crude requirement was to pay back 3,000 bbls of crude owed to Company B. Further, one expected to receive 1,000 bbls of crude from Company C. However, it was learned from Company C that Company B owes them 2,000 bbls. Instead of moving a lot of excess crude around the respective supply chains and incurring the associated costs and efficiency losses, it is agreed with Companies B and C to “Net Out” the barrels owed. Company A sends only 2,000 bbls to Company B. Sending Company B only 2,000 bbls instead of 3,000 bbls provides the additional 1,000 bbls that would have been needed from Company C. The present invention easily handles and supports these kind of deals and all of the inventory and accounting record keeping associated with such a deal.

The present invention supports secure inclusion of internal and external customers 1206, material and service suppliers (customer deliveries 1204) in supply chain activity. The present invention's ability to receive and send data simultaneously from/to all supply chain participants is extremely supportive of service and value creation. The present invention supports all total quality management (“TQM”) and just-in-time (“JIT”) processes. Customers and service providers are able to ‘see’ the delivery schedules for their goods, related quality information, process invoices faster, eliminate or more quickly resolve goods and payment imbalances, reduce paper work, phone tag and other inefficiencies resulting for the present lack of tools that less effectively reflect supply chain activity. All supply chain participants, none being more important than customers 1206, benefit from the present invention's virtual reality functionality. More efficient information transfer with service providers support more efficient supply chain movements, reduces uncertainly, and thus reduces the needed inventory requirements and supply and delivery disruptions. The present invention's easily configurable architecture for customer functionality and security features supports customer 1206 and other external interfaces. The ability to get faster feedback from customers 1206 on present and future requirements is crucial to the planning activity process 1208 in that the customer 1206 is the principle and the driving force for the entire supply chain. In the case of the LPG sales example, the present invention keeps customers better informed of their expected deliveries. LPG sales of 2,000,000 bbls by barge, rail, pipeline and truck can result in hundreds of movements, over various routes, involving many transporters, suppliers and others. In the example case, the present invention provides the customer 1206 the ability to track deliveries across all modes of transportation, with seamless linkage to all other related supply chain participants, such as credit 1216, accounting 1202, manufacturing1230, scheduling, Trading and other supply chain participants. Knowing any variance on the customer's 1206 purchase of the 2,000,000 bbls is important input into the planning process 1208. In the instant example the sale was supply driven. Customer's 1206 failure to buy or take delivery for any reason will require manufacturing rate reductions with other implications throughout the supply chain. The present invention's ability to accommodate all aspects of supply chain activity maximizes the chance for effective response to changes for any reason. The present invention's superior technology will allow superior realization of the need to acquire the 1,000,000 bbls of crude and sell the 2,000,000 bbls of LPG. The present invention ensures that the supply chain efficiently and optimally handles all of the supply chain functions that are associated with completing the transactions, and accommodate supply chain adjustments as required, while meeting all of the supply chain organizational, operational, and administrative requirements.

The invention, therefor, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A computer system having a processor and memory coupled to said processor, said computer system comprising:
a virtual environment operating on said processor; and
a set of one or more objects operating within said virtual environment, each of said objects modeling a unit of goods or services, each of said objects constructed and arranged to interact with said virtual environment;
wherein the interaction of said set of objects generates an emergent behavior that correlates with real-world behavior of acquisition, movement, production, processing, accounting and distribution of goods in a manufacturing, commodities trading or services business.
